(19) United States
(12) Patent Application Publication
(10) Pub. No.: US 2024/0118076 A1
(43) Pub. Date: Apr. 11, 2024

(54) System and Method for Coupled Ocean-Acoustic Data Assimilation

(71) Applicant: The Government of the United States of America, as represented by the Secretary of the Navy, Arlington, VA (US)

(72) Inventors: Matthew J. Carrier, Covington, LA (US); Hans E. Ngodock, Slidell, LA (US); Josette P. Fabre, Slidell, LA (US)

(73) Assignee: The Government of the United States of America, as represented by the Secretary of the Navy, Arlington, VA (US)

(21) Appl. No.: 18/471,664

(22) Filed: Sep. 21, 2023

Related U.S. Application Data
(60) Provisional application No. 63/411,604, filed on Sep. 29, 2022.

(51) Int. Cl. G01C 13/00; G06N 3/08

(52) U.S. Cl. CPC G01C 13/002; G06N 3/08

(57) ABSTRACT

A method of determining ocean state. The method may include receiving, by a processing device, data associated with a prior ocean forecast state, and receiving, by the processing device, data associated with a first set of ocean temperature and salinity observations. The method may include receiving, by the processing device, data associated with a first set of ocean acoustic pressure observations. The method may include determining, by the processing device, a correction to the prior ocean forecast state based on a forward acoustic model, on an adjoint acoustic model, on the data associated with a first set of ocean temperature and ocean salinity observations, and on the data associated with a first set of ocean acoustic pressure observations, and generating, by the processing device, a current ocean state based on the determined correction.

### CROSS-REFERENCE

This Application is a nonprovisional application of and claims the benefit of priority under 35 U.S.C. § 119 based on U.S. Provisional Patent Application No. 63/411,604 filed on Sep. 29, 2022. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case # 211166.

### TECHNICAL FIELD

The present disclosure is related to ocean forecasting, and more specifically to, but not limited to, the use of ocean acoustic pressure observations for ocean model analysis and forecasting.

### BACKGROUND

Previous methods have focused on two distinct approaches: acoustic tomography and variational retrievals. The use of acoustic tomography for measuring ocean properties was postulated by Munk and Wunsch (1979) and examined in numerous works since then. The basic idea behind acoustic tomography is to conduct an inversion for environmental sound speed by minimizing the difference between modeled and measured acoustic travel times. Cornuelle et al. (1985) conducted an experiment comparing the tomography-derived sound speed environments to in-situ measurements and found strong correlation between them. Skarsoulis and Send (2000) examined the use of acoustic tomography in the presence of strong nonlinear dependency between sound speed and acoustic travel time variations. And a more recent study by Dushaw (2019) examined the impact of ocean acoustic tomography in combination with Argo floats. This method has the disadvantage that it is computationally intensive and can provide inaccurate final results.

The other method, variational retrievals, relies on acoustic pressure data assimilation. Acoustic pressure assimilation is different than acoustic tomography in that rather than examining the difference in acoustic travel times between modeled and measured values, acoustic pressure assimilation involves differencing the recorded pressure (as captured by hydrophones) with modeled values. Typically, acoustic pressure is modeled using some form of a parabolic equation based approach, such as that used in the Navy's Range-dependent Acoustic Model (RAM; Collins et al., 1996). These models use information regarding the sediment conditions, the surface wind and wave state, and the environmental sound speed. The use of variational techniques in assimilating acoustic pressure observations has been examined in previous studies. Most notably by Hursky et al. (2004) where the tangent linear and adjoint of a parabolic equation model is derived and used to assimilate acoustic pressure measurements in order to adjust the assumed sound speed profile. This method aims to produce a retrieval of environmental temperature and salinity profiles, which in turn can be assimilated by an ocean model in order to update the ocean state estimate. While a better approach than tomography, this method has the disadvantage of a double-assimilation, where the assumed errors in the observations are counted twice, once during the retrieval and again during the assimilation of the retrieved profile. This can substantially reduce the impact of the acoustic pressure observation on the ocean model analysis.

A very recent effort by Storto et al. (2021) aimed to update the ocean model directly via the variational assimilation of acoustic pressure observations. In their approach they utilized an observation operator built into a three-dimensional variational (3DVAR) ocean data assimilation system in order update the ocean model analysis with acoustic pressure observations. Their observation operator is based on an artificial intelligence method known as a neural network (NN). This method, while functional, has the disadvantage of the limitations of the training method/period, is vulnerable to large error in cases that deviate from the training set, and result in poor improvement to the ocean model temperature and salinity fields.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

Disclosed aspects provide the ability to use measured acoustic pressure observations to update an ocean model analysis (three-dimensional temperature, salinity, pressure fields, and/or the like) for the purposes of state estimation and/or ocean forecasting via advanced data assimilation systems and methods in accordance with one or more disclosed aspects, which can be shown in FIG. 1. As shown, local observations 102 can be collected by a variety of sources and devices, such as from gliders 118, profiling floats 120, and expendable bathythermographs (XBTs) 122. According to some aspects, this may include local observations taken by a vessel 124, such a ship, boat, etc. In some cases, the vessel 124 may include the fleet, such as within an exercise region. Acoustic observations 104 can be collected from a variety of sources and devices, such as by one or more hydrophones 110 (e.g., on vertical line arrays, on-board the platform, or the like). The acoustic pressure hydrophones 110 can record come from numerous sources. According to some aspects, some embodiments described herein may consider ships of opportunity, such as shown on the map 112 of Earth, showing a heat-map of the shipping lanes, indicating where there may be an abundance of shipping to collect acoustic pressure from. Both observation types (ocean and acoustic) can be “assimilated” by the advanced data assimilation system 106 (lower portion of FIG. 1), which may include a computer system (such as the one described herein in FIG. 44). FIG. 1 shown the ocean analysis increments (e.g., adjustments brought by observations) on a computer read-out/display on the lower left side 114, on the lower right side 116 is an output (e.g., can be an image, movie, etc.) of these increments backward and forward in time that is provided by the 4DVAR method. Any component of FIG. 1 may include and/or be connected to a computer system (such as the one described herein in FIG. 44.

An ocean analysis equation, forward acoustic model, and adjoint acoustic model can be shown in FIGS. 2 and 3. According to some aspects, the ocean model and observations can be merged through a weighted least-squares minimization. By tying the acoustic models (forward and adjoint models) directly to the ocean model data assimilation, one or more disclosed aspects provide a novel approach by correcting the ocean model directly using acoustic pressure observations.

The advantages one or more disclosed embodiments include:
1. Computational efficiency. One or more disclosed embodiments are computationally faster than the acoustic tomography method while yielding superior results.
2. Improved accuracy over the retrieval method. Since the acoustic pressure observations are assimilated once in one or more disclosed embodiments (e.g., compared to, essentially, twice as in the retrieval method), the impact of the assumed observation errors may be accounted for once.

This allows for more impact from the acoustic pressure observations on the final ocean state analysis.

For variational assimilation, the tangent linear and adjoint operators must be derived from the original nonlinear model. The RAM tangent linear and adjoint operators are then interfaced with the larger NCOM-4DVAR or 3DVAR systems (Ngodock and Carrier, 2014a; Ngodock and Carrier, 2014b) as observations operators. NCOM-4DVAR is a weak-constraint analysis system based on the indirect representer method of Bennett (1992, 2002) and Chua and Bennett (2001). The system is derived from the incremental formulation of the variational cost function (Courtier 1997), where the time dimension is omitted here for simplicity:

$$J ( δ x ) = \frac{1}{2} δ {x}^{T} {B}^{- 1} δ x + \frac{1}{2} {( H δ x - d )}^{T} {R}^{- 1} ( H δ x - d )$$

where δx is the increment to the state variable, B is the background error covariance, H is the observation operator, and R is the observation error covariance. d is the set of innovations defined as:

d=y−Hx^{b}

where y is the observation set and x^{b} is the model background. When taking the derivative

and setting it equal to zero one can find the minimum of the cost function. After some arithmetic, the analysis equation can be derived from this equality as

δx^{a}=BH^{T}(HBH^{T}+R)⁻¹d

For 4DVAR, the background error covariance can be expanded to include the operation of

the tangent linear and adjoint operators to form a four-dimensional background error covariance such that this equation is expanded to:

δx^{a}=MΣCΣ^{T}M^{T}H^{T}(HMΣCΣ^{T}M^{T}H^{T}+R)⁻¹d

where M is the tangent linear ocean model operator, M^{T} is the adjoint model, and ΣCΣ^{T} is a static error correlation (C) symmetrically multiplied by the error standard deviation (Σ) that describes the initial condition error or the model error. The RAM tangent linear and adjoint operators are linked to NCOM-4DVAR as additional observation operators contained within H and H^{T}. In this way the ocean variables of temperature and salinity can be mapped to the acoustic observation space (to be compared to acoustic observations) via H, and acoustic observation information can be passed to the ocean adjoint model via H^{T}. In addition to the tangent linear and adjoint models of RAM, the H and H^{T} operators also contain the tangent linear and adjoint of the sound speed equation. In this case, the sound speed equation used is known in the community as “Chen-Millero-Li” and is described collectively in Chen and Millero (1977) and Millero and Li (1994).

Typically, the inversion in the above equation is solved using a linear solution method such as one of the conjugate gradient approaches. This requires multiple applications of the tangent linear and adjoint model over a number of iterations until the conjugate gradient converges to a solution. Depending on the size of the problem (model domain size, horizontal and vertical resolution, and length of the assimilation window) the 4DVAR can be computationally expensive. The above equation can be simplified by reducing the tangent linear and adjoint of the ocean model to identity matrices such that it becomes a 3DVAR method:

δxₐ=ΣCΣ^{T}M^{T}H^{T}(HΣCΣ^{T}H^{T}+R)⁻¹(y−Hx_{b})

The inverse in this equation is faster to solve as the covariance ΣCΣ^{T} can be applied in an efficient manner. In the case of the data assimilation algorithms used in this demonstration, the correlation matrix, C, is provided by an operator based on the implicit solution to a diffusion equation (Weaver and Courtier, 2001; Carrier and Ngodock, 2010) and is computationally efficient. There is no account for the time variability of the observations on the solution in this equation, however, as that is a necessary consequence of using a simpler method than 4DVAR. The dynamical balance relationships are also missing in this equation, but they can be approximated by adding additional operators. Following the work of Weaver et al. (2005), a linearized “balance operator” can be constructed based on geostrophy and hydrostatics. Doing so would alter this equation so that the embedded background error covariance would have the additional operators:

δxₐ=K_{b}ΣCΣ^{T}K_{b}^{T}H^{T}(HK_{b}ΣCΣ^{T}K_{b}^{T}H^{T}+R)⁻¹(y−Hx_{b})

where Kb is the linear balance operator (and K_{b}^{T} its adjoint). This equation is the base form of the DVAR used in this approach, with the software derived from the larger 4DVAR system. These models can be applied using an Observing System Simulation Experiment (OSSE) methodology.

The present disclosure provides for a method of determining ocean state. The method may include receiving, by a processing device, data associated with a prior ocean forecast state, and receiving, by the processing device, data associated with a first set of ocean temperature and salinity observations. The method may include receiving, by the processing device, data associated with a first set of ocean acoustic pressure observations. The method may include determining, by the processing device, a correction to the prior ocean forecast state based on a forward acoustic model, on an adjoint acoustic model, on the data associated with a first set of ocean temperature and ocean salinity observations, and on the data associated with a first set of ocean acoustic pressure observations, and generating, by the processing device, a current ocean state based on the determined correction.

The present disclosure provides for a system for determining an ocean state. The system may include a processing device, and a memory device operably coupled to the processing device, the memory device storing computer-readable instructions that, when executed, cause the processing device to perform a method. The method may include receiving data associated with a prior ocean forecast state, and receiving data associated with a first set of ocean temperature and salinity observations. The method may include receiving data associated with a first set of ocean acoustic pressure observations. The method may include determining a correction to the prior ocean forecast state based on a forward acoustic model, an adjoint acoustic model, the data associated with a first set of ocean temperature and ocean salinity observations, and the data associated with a first set of ocean acoustic pressure observations, and generating a current ocean state based on the determined correction.

The present disclosure provides for a non-transitory computer readable medium comprising computer-readable instructions, the computer-readable instructions, when executed, cause a processing device to perform a method. The method may include receiving data associated with a prior ocean forecast state, and receiving data associated with a first set of ocean temperature and salinity observations. The method may include receiving data associated with a first set of ocean acoustic pressure observations. The method may include determining a correction to the prior ocean forecast state based on a forward acoustic model, an adjoint acoustic model, the data associated with a first set of ocean temperature and ocean salinity observations, and the data associated with a first set of ocean acoustic pressure observations, and generating a current ocean state based on the determined correction.

### BRIEF DESCRIPTION OF THE DRAWINGS

FIG. 1 illustrates an exemplary diagram for the purposes of state estimation and/or ocean forecasting via advanced data assimilation systems in accordance with one or more disclosed aspects.

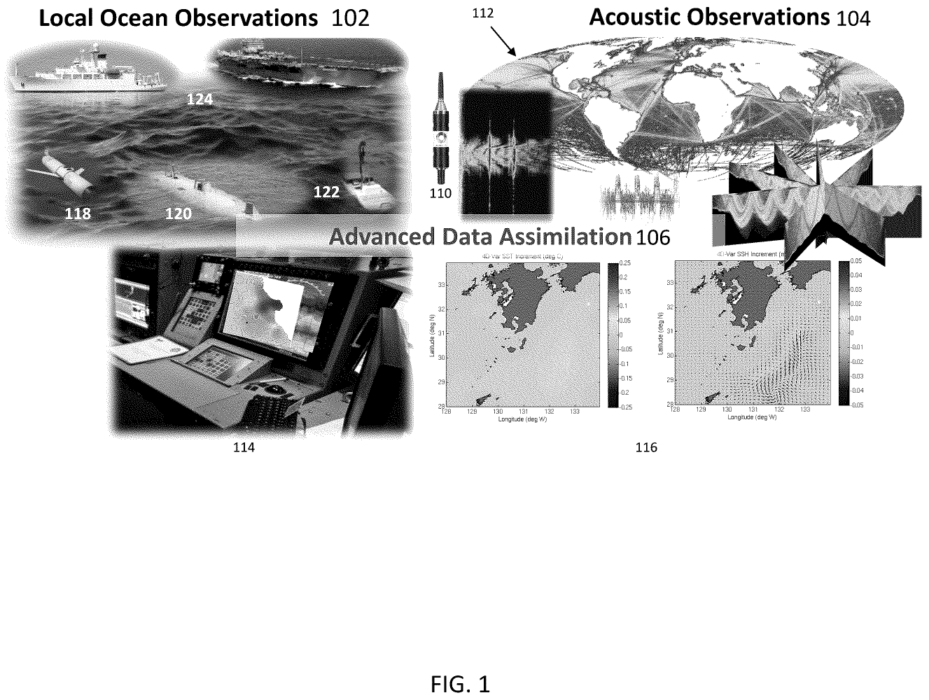

FIG. 2 illustrates: An ocean analysis equation in accordance with one or more disclosed aspects.

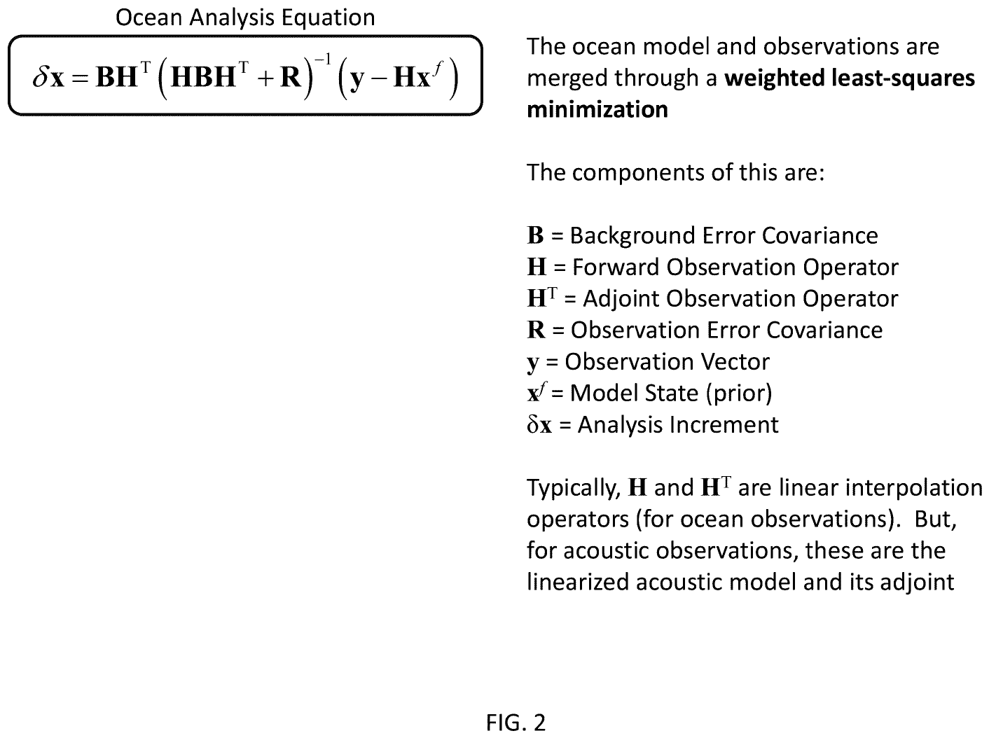

FIG. 3 illustrates: An ocean analysis equation, forward acoustic model, and adjoint acoustic model in accordance with one or more disclosed aspects.

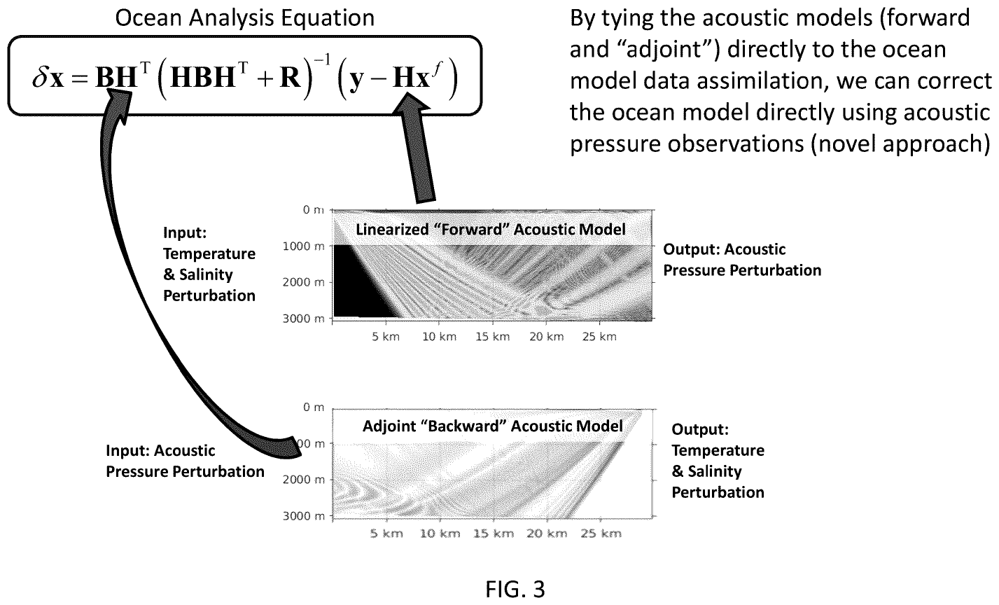

FIG. 4 illustrates: NCOM Mid-Atlantic Bight 3 km domain sea surface temperature on 1 May, 2021. The acoustic source locations used for the coupled ocean-acoustic adjoint runs are indicated. Short-range radials (0-3) extend out ˜2 km due east from each source location along the shelf-break; long-range radial (4) extends out ˜30 km due south from radial on far East side of domain in accordance with one or more disclosed aspects.

FIG. 5 illustrates: Transmission loss (in dB) at 50 Hz (left panels) and 300 Hz (right panels) for radial 0 (panels a and e), radial 1 (panels b and f), radial 2 (panels c and g), and radial 3 (panels d and h) in accordance with one or more disclosed aspects.

FIG. 6 illustrates: Adjoint sensitivity of acoustic pressure out in range to acoustic pressure back toward the source location (values are dimensionless, normalized by largest sensitivity value within each radial). Sensitivity shown for 50 Hz (left panels) and 300 Hz (right panels) for radial 0 (panels a and e), radial 1 (panels b and f), radial 2 (panels c and g), and radial 3 (panels d and h) in accordance with one or more disclosed aspects.

FIG. 7 illustrates: Adjoint sensitivity of acoustic pressure at the end of the range/depth plane to environmental profiles of temperature (red line) and salinity (blue line) for 50 Hz (top panels) and 300 Hz (bottom panels) for radial 0 (panels a and e), radial 1 (panels b and f), radial 2 (panels c and g), and radial 3 (panels d and h) in accordance with one or more disclosed aspects

FIG. 8 illustrates: Adjoint sensitivity of acoustic pressure out in range (from each of the four short-range radials) to temperature (left panels) and salinity (right panels) at 0 m depth for 50 Hz (top panels) and 300 Hz (bottom panels); background currents displayed as arrow vectors in accordance with one or more disclosed aspects. Adjoint sensitivity generated after forcing each radial at 0 z 1 May, 2021 and running the coupled ocean-acoustic adjoint model back 120 hours to 0 z 26 Apr. 2021 in accordance with one or more disclosed aspects.

FIG. 9 illustrates: Same as FIG. 8, but for 50 m depth in accordance with one or more disclosed aspects.

FIG. 10 illustrates: Transmission loss (dB) at 50 Hz (top panel) and 300 Hz (bottom panel) along longrange radial (source location shown in FIG. 4) in accordance with one or more disclosed aspects.

FIG. 11 illustrates: Adjoint sensitivity of acoustic pressure at mid-range (12 km; left panels) and longrange (29 km; right panels) to acoustic pressure back to the source for 50 Hz (top panels) and 300 Hz (bottom panels); values are not normalized in accordance with one or more disclosed aspects.

FIG. 12 illustrates: Adjoint sensitivity of acoustic pressure at mid-range (12 km) to environmental temperature (red line) and salinity (blue line) at (a) 2 km, (b) 4 km, (c) 6 km, and (d) 10 km; all sensitivities calculated at 50 Hz. Values are normalized by highest magnitude (either temperature or salinity) across all four profile locations in accordance with one or more disclosed aspects.

FIG. 13 illustrates: Same as FIG. 12, but for 300 Hz in accordance with one or more disclosed aspects.

FIG. 14 illustrates: Adjoint sensitivity of acoustic pressure at long-range (29 km) to environmental temperature (red line) and salinity (blue line) at (a) 2 km, (b) 6 km, (c) 20 km, and (d) 24 km; all sensitivities calculated at 50 Hz. Values are normalized by highest magnitude (either temperature or salinity) across all four profile locations in accordance with one or more disclosed aspects.

FIG. 15 illustrates: Same as FIG. 14, but for 300 Hz in accordance with one or more disclosed aspects.

FIG. 16 illustrates: NCOM sea surface temperature (SST, ° C.) valid 1 May, 2021 from the nature run (left panel) and the simulated ocean (right panel). Ocean current vectors overlaid on each plot in accordance with one or more disclosed aspects.

FIG. 17 illustrates: Average temperature profile root mean square error (° C.) computed from 1-31 May, 2021 by comparing the free run simulated ocean model to the nature run in accordance with one or more disclosed aspects.

FIG. 18 illustrates: Nature run model bathymetry (color contours) and the location of the four acoustic source locations within the experiment domain (numbered white dots) in accordance with one or more disclosed aspects.

FIG. 19 illustrates: Transmission loss (TL) along each of the four acoustic radials configured within the nature run domain (0, 1, 2, and 3). TL values are displayed in dB. The time is 0 Z 1 May 2021. Location of each simulated hydrophone along the vertical line array is indicated by black dots near the end of each radial in accordance with one or more disclosed aspects.

FIG. 20 illustrates: Absolute difference between NR and FR (top panels), analysis (middle panels), 24-hr forecast (bottom panels), for temperature (left panels) and salinity (right panels) from 1-31 May, 2021 for the environmental profile at the source location for radial 0 in accordance with one or more disclosed aspects.

FIG. 21 illustrates: Average profile root mean square error in temperature (left panel) and salinity (right panel) for the FR (black line), 24-hr forecast (blue line), and analysis (red line) as compared to the NR from 1-31 May, 2021 for the environmental profile at the source location for radial 0 in accordance with one or more disclosed aspects.

FIG. 22 illustrates: Same as FIG. 20, but for the environmental profile at the source location for radial 1 in accordance with one or more disclosed aspects.

FIG. 23 illustrates: Same as FIG. 21, but for the environmental profile at the source location for radial 1 in accordance with one or more disclosed aspects.

FIG. 24 illustrates: Same as FIG. 20, but for the environmental profile at the source location for radial 2 in accordance with one or more disclosed aspects.

FIG. 25 illustrates: Same as FIG. 21, but for the environmental profile at the source location for radial 2 in accordance with one or more disclosed aspects.

FIG. 26 illustrates: Same as FIG. 20, but for the environmental profile at the source location for radial 3 in accordance with one or more disclosed aspects.

FIG. 27 illustrates: Same as FIG. 21, but for the environmental profile at the source location for radial 3 in accordance with one or more disclosed aspects.

FIG. 28 illustrates: NCOM-4DVAR analysis increments for temperature (left panels) and salinity (right panels) at the surface (top panels) and at 50 m depth (bottom panels) valid at 0 z 1 May, 2021. The four acoustic source locations are indicated by black dots. Ocean currents overlaid on each plot using arrow vectors in accordance with one or more disclosed aspects.

FIG. 29 illustrates: Absolute difference in temperature (° C.) for NR minus FR (left panel) and minus 24-hr forecast (right panel) in 1° by 1° box surrounding radial 0 (black dot) at 25 m depth on 15 May, 2021 in accordance with one or more disclosed aspects.

FIG. 30 illustrates: Same as FIG. 29, but for 1° by 1° box surrounding radial 1 in accordance with one or more disclosed aspects.

FIG. 31 illustrates: Same as FIG. 29, but for 1° by 1° box surrounding radial 2 in accordance with one or more disclosed aspects.

FIG. 32 illustrates: Same as FIG. 29, but for 1° by 1° box surrounding radial 3 in accordance with one or more disclosed aspects.

FIG. 33 illustrates: NCOM model domain showing SST (° C.) and surface ocean currents (arrow vectors) at 0 z 1 May, 2021. Acoustic source locations indicated by white dots and labeled by radial number (0 and 1) in accordance with one or more disclosed aspects.

FIG. 34 illustrates: Mean acoustic pressure profile (real component only) computed from 1-31 May, 2021 for the nature run (NR, solid red line) and the free run (FR, solid blue line) at the end of (a) radial 0 and (b) radial 1. Standard deviation of the acoustic pressure profile shown in shaded regions for the NR (red shading) and FR (blue shading) in accordance with one or more disclosed aspects.

FIG. 35 illustrates: Mean temperature profile computed from 1-31 May, 2021 for the nature run (NR, solid red line) and the free run (FR, solid blue line) at the acoustic source location for (a) radial 0 and (b) radial 1. Standard deviation of the temperature profile shown in shaded regions for the NR (red shading) and FR (blue shading) in accordance with one or more disclosed aspects.

FIG. 36 illustrates: Root mean square error for (a) temperature and (b) salinity from the free run (black line), 3DVAR experiment (blue lines), and 4DVAR experiment (red lines). Error in 24-hr forecast shown as solid line; error in analysis shown as dashed lines. RMSE calculated using the nature run profiles at the source location for radial 0 in accordance with one or more disclosed aspects.

FIG. 37 illustrates: Same as FIG. 36, but for the source profile location for radial 1 in accordance with one or more disclosed aspects.

FIG. 38 illustrates: (a) 3DVAR temperature analysis increment (° C.) at 25 m depth at 0 z 1 May, 2015 and (b) 24-hr evolution of the 3DVAR analysis increment at 25 m depth valid at 0 z 2 May, 2021; (c) 4DVAR temperature analysis increment (° C.) at 25 m depth at 0 z 1 May, 2015 and (d) 24-hr evolution of the 4DVAR analysis increment at 25 m depth valid at 0 z 2 May, 2021 in accordance with one or more disclosed aspects.

FIG. 39 illustrates: Same as FIG. 38, but for analysis increments at 0 z 15 May, 2021 and forecast perturbation evolution at 0 z 16 May, 2021 in accordance with one or more disclosed aspects.

FIG. 40 illustrates: Same as FIG. 38, but for analysis increments at 0 z 31 May, 2021 and forecast perturbation evolution at 0 z 1 Jun. 2021 in accordance with one or more disclosed aspects.

FIG. 41 illustrates: Mean acoustic pressure profile (real component only) computed from 1-31 May, 2021 for the nature run (NR, solid red line) and the 3DVAR 24-hr forecast (3DV, solid blue line) at the end of (a) radial 0 and (b) radial 1; mean acoustic pressure profile (real component only) computed from 1-31 May, 2021 for the nature run (NR, solid red line) and the 4DVAR 24-hr forecast (4DV, solid blue line) at the end of (c) radial 0 and (d) radial 1 Standard deviation of the acoustic pressure profile shown in shaded regions for the NR (red shading) and the 3DVAR or 4DVAR (blue shading) in accordance with one or more disclosed aspects.

FIG. 42 illustrates: Mean temperature profile computed from 1-31 May, 2021 for the nature run (NR, solid red line) and the 3DVAR 24-hr forecast (3DV, solid blue line) at the acoustic source location for (a) radial 0 and (b) radial 1; mean temperature profile computed from 1-31 May, 2021 for the nature run (NR, solid red line) and the 4DVAR 24-hr forecast (4DV, solid blue line) at the acoustic source location for (c) radial 0 and (d) radial 1 Standard deviation of the temperature profile shown in shaded regions for the NR (red shading) and the 3DVAR or 4DVAR (blue shading) in accordance with one or more disclosed aspects.

FIG. 43 illustrates an example method, in accordance with one or more disclosed aspects.

FIG. 44 illustrates a diagram of an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

One or more aspects described herein may be used to facilitate the use of ocean acoustic pressure observations for ocean model analysis and forecasting.

Disclosed embodiments provide for one or more aspects to improve the ocean state estimation and model forecast via the assimilation of acoustic observations by using the adjoint and tangent linear of the Navy's operational acoustic model, the Range-dependent Acoustic Model (RAM) and integrating them as observation operators within the larger Navy Coastal Ocean Model (NCOM) four dimensional variational (4DVAR) and 3DVAR assimilation systems.

### 1.0 introduction

Accurate ocean state estimation is vital to producing useful ocean model predictions for both near and long-term forecasts. These ocean state estimates, or analyses, rely on both ocean observations and advanced data assimilation methods, such as the four-dimensional variational (4DVAR) technique. Ocean observations, however, are scarce, especially in the sub-surface. Most in-situ sub-surface ocean measurements are obtained through the Argo profiling float program (Roemmich et al., 2001) with nearly 4,000 floats as of June 2022, and localized short-term glider deployments. The remaining observations are mainly surface in nature, i.e. sea surface temperature (SST) and height (SSH) as measured from satellites. There exists another sub-surface ocean measurement type that is not widely used in the ocean modeling community through data assimilation, e.g. the ocean acoustic pressure observation. Acoustic pressure observations are obtained via hydrophone and can potentially provide useful information regarding the ocean environment, specifically temperature and salinity; this is because sound propagation through the ocean is sensitive to these ocean variables through sound speed. Acoustic pressure observations are particularly powerful because these act not as pointwise measurements, but as an integrated measurement over distance (potentially tens of kilometers). And, if the sound source is a moving target (such as a ship of opportunity) the area of the ocean that can be observed using one vertical line array of hydrophones could be expansive.

One or more aspects described herein detail the work accomplished under R&D from software development, to sensitivity experiments, up to ocean data assimilation tests. One or more aspects described herein can be organized as follows: (1) how the acoustic data assimilation components are coupled to the larger ocean data assimilation software and a discussion of a series of sensitivity studies and their potential impact on real data assimilation experiments; (2) a description of an ocean data assimilation experiment where acoustic pressure observations are used to update the ocean model analysis and short-term forecast; and (3) a comparison of two competing methods of data assimilation when utilizing acoustic pressure observations.

Aspects described here are organized in the following manner: section 2 provides a description of the coupled ocean-acoustic adjoint model; section 3 provides a description regarding the adjoint sensitivity experiment setup; section 4 provides a description examining the results of the experiments; and a concluding analysis follow in section 5.

### 2.0 Coupled Ocean-Acoustic Software Construction and Adjoint Sensitivity Experiment

Operational ocean modeling relies heavily upon the assimilation of observations to make reasonably accurate forecasts. The ocean is significantly under-sampled, especially in the sub-surface where the observations are limited to an array of profiling floats (Roemmich et al., 2001) or gliders. There is one observation that is taken, however, that can provide sub-surface information regarding the temperature and salinity that is not routinely used in ocean modeling: ocean acoustic observations. These observations are collected in the form of acoustic pressure via hydrophones, typically arranged along vertical lines from the surface down to some depth. The modeling of acoustic pressure relies on environmental information in the form of sound speed profiles (along with sediment conditions and surface wind and wave state) in order to simulate the propagation of acoustic energy through the ocean. Using inverse methods, one can use an acoustic model and observations to recover information regarding the ocean environment and use this information to update the ocean model simulation. Prior to conducting such experiments, however, it is important to characterize the sensitivity of the acoustic pressure simulation to the environmental input; this helps to properly design the data assimilation system and provide guidance on the expected results and impacts. Traditionally, sensitivity information had been obtained in a time-consuming manner where one perturbs the model initial condition variable-by-variable and grid point-by-grid point while recording the changes to the model solution after each run. A more computationally efficient approach is to use the adjoint of the model in question in order to determine the sensitivity of the output to each input variable.

The adjoint of a model is the linear transposition of its tangent linear counterpart; and the tangent linear model is found by linearizing the nonlinear model around its background state (Li et al., 1993; Ngodock et al., 2017). Whereas the tangent linear model describes the evolution of an initial perturbation to the nonlinear model over time and space, the adjoint integrates backwards providing the initial perturbation required to produce the final perturbed state that the adjoint is initialized with. In doing so, the adjoint determines the input variables that the final solution is most sensitive to. In the case of the ocean-acoustics, this inverse method can be used to determine which ocean variables, locations, and times the acoustic propagation is most sensitive to (for a given source depth, location, and frequency). In this present effort, the adjoint of an acoustic model has been developed in order to examine the sensitivity of acoustic pressure to environmental profiles provided by the ocean forecast model.

Similar adjoint-based work with ocean acoustic models has been done within the community in the past. Hermand et al. (2006) used the adjoint of a similar parabolic equation model to examine geoacoustic inversion problems, as did Le Gac et al. (2004). Thode and Kim (2004) used the adjoint model to examine the derivatives of a waveguide field with respect to sound speed, density, and frequency. Meyer and Hermand (2005) used the adjoint method with a wide-angle parabolic equation model to invert for the bottom properties in their model. Finally, Li et al. (2014) used the adjoint method to examine the inversion of an internal wave-perturbed sound speed field through acoustic data assimilation (with both sound speed and acoustic pressure observations). This present work is distinct, however, in that the adjoint of the US Navy's acoustic model, the Range-dependent Acoustic Model (RAM; Collins et al., 1996), is coupled directly to the adjoint of the Navy Coastal Ocean Model (NCOM; Barron et al., 2006), effectively making the adjoint of RAM an “observation operator” of the adjoint of NCOM. In this way, the coupled adjoint sensitivity can be examined to the input variables of temperature and salinity through space and time.

The adjoint sensitivity of acoustic pressure to the ocean model temperature and salinity is examined for a Mid-Atlantic Bight NCOM domain for four source locations, each at a depth of 50 m and frequencies of 50 and 300 Hz (for short ranges, ˜2000 m); a short examination of a mid-range (12 km) and a long-range (30 km) case is provided as well. This work provides some key generalizations that have implications for both adaptive ocean sampling (to aid accurate acoustic modeling) and acoustic observation assimilation via a coupled ocean-acoustic assimilation system.

### 2.1 Coupled Ocean-Acoustic Model

RAM is a parabolic equation model solved using finite difference methods as a split-step Padé algorithm (Collins et al., 1996). The model is solved on a two-dimensional range-depth plane, with r as the horizontal range from some source and z as the depth from the surface of the ocean. From Collins et al. (1996), the spreading factor r^{-1/2} is removed from the complex pressure field, p, and the derivation of RAM begins with the far-field version of the reduced wave equation,

$$\frac{{\partial }^{2} p}{\partial {r}^{2}} + \frac{{\partial }^{2} p}{\partial {z}^{2}} + {k}^{2} p = 0 \qquad ( 1 )$$

where k is the wavenumber. Factoring the operator in Eq. (1) gives

$$( \frac{\partial }{\partial r} + i {{k}_{o} ( I + X )}^{1 / 2} ) ( \frac{\partial }{\partial r} - i {{k}_{o} ( I + X )}^{1 / 2} ) p = 0 \qquad ( 2 )$$

where kₒ=ω/cₒ(ω is the angular frequency and cₒ is a representative phase speed) and the operator X is given by

$$X = {k}_{o}^{- 2} ( ρ \frac{\partial }{\partial z} \frac{1}{ρ} \frac{\partial }{\partial z} + ( {k}^{2} - {k}_{o}^{2} ) I ) . \qquad ( 3 )$$

If the outgoing energy dominates the backscattered energy, Eq. (2) becomes

$$\frac{\partial p}{\partial r} = i {{k}_{o} ( I + X )}^{1 / 2} p . \qquad ( 4 )$$

Then, the formal solution of Eq. (4) is given by

p(r+αr,z)=exp(ikₒΔr(I+X)^{1/2})p(r,z) (5)

where Δr is the range step. Per Collins et al. (1996), the exponential of the operator square root that appears in Eq. (5) is replaced by a rational approximation to obtain the final split-step Padé algorithm,

$$p ( r + Δ r , z ) = exp ( {ik}_{o} Δ r ) ( I + {\sum }_{j = 1}^{n} \frac{{a}_{j , n} X}{I + {β}_{j , n} X} ) p ( r , z ) \qquad ( 6 )$$

where I is the identity operator and α_{j,n} and β_{j,n} are precomputed coefficients of the split-step Padé algorithm for solving the original wave equation implicitly.

For variational assimilation, the tangent linear and adjoint operators must be derived from

the original nonlinear model; this forms the basis operators for the Variational Range-dependent Acoustic Model (VRAM) data assimilation system. In the case of RAM, the algorithm is linear in terms of acoustic pressure (p), but nonlinear in the differential operator, X, which depends upon the wavenumber k in a nonlinear fashion (Ngodock et al., 2017). The original VRAM tangent linear and adjoint operators were derived directly from the tangent linear and adjoint of Eq. (6), see Ngodock et al. (2017). VRAM was recently updated, however, to take advantage of the wrapper software provided by the NSPE program suite, which handles setting various aspects of the acoustic modeling. The adjoint and tangent linear operators of this new version of VRAM uses the adjoint of finite difference method (AFD) to derive the operators directly from the numerical code of RAM itself. The new adjoint of RAM still allows for updating the sound speed profile via the inversion of acoustic pressure as in Ngodock et al. (2017). In order to invert this to environmental temperature and salinity, the tangent linear and adjoint of the sound speed equation was derived and linked to VRAM. In this case, the sound speed equation used is known in the community as “Chen-Millero-Li” and is described collectively in Chen and Millero (1977) and Millero and Li (1994).

With this inversion to temperature and salinity in place, the VRAM tangent linear and adjoint operators are able to be interfaced with the larger NCOM Four-Dimensional Variational (4DVAR) system (Ngodock and Carrier, 2014a; Ngodock and Carrier, 2014b) as observations operators. NCOM-4DVAR is a weak-constraint analysis system based on the indirect representer method of Bennett (1992, 2002) and Chua and Bennett (2001). The system is derived from the incremental formulation of the variational cost function (Courtier 1997), where the time dimension is omitted here for simplicity:

$$J ( δ x ) = \frac{1}{2} δ {x}^{T} {B}^{- 1} δ x + \frac{1}{2} {( H δ x - d )}^{T} {R}^{- 1} ( H δ x - d ) \qquad ( 7 )$$

where δx is the increment to the state variable, B is the background error covariance, H is the observation operator, and R is the observation error covariance. d is the set of innovations defined as

d=y−Hx^{b} (8)

where y is the observation set and x^{b} is the model background. When taking the derivative of Eq. (7) and setting it equal to zero one can find the minimum of the cost function. After some arithmetic, the analysis equation can be derived from this equality as

δx^{a}=BH^{T}(HBH^{T}+R)⁻¹d. (9)

For 4DVAR, the background error covariance in Eq. (9) can be expanded to include the operation of the tangent linear and adjoint operators to form a four-dimensional background error covariance such that Eq. (9) is expanded to:

δx^{a}=MΣCΣ^{T}M^{T}H^{T}(HMΣCΣ^{T}M^{T}H^{T}+R)⁻¹d (10)

where M is the tangent linear ocean model operator, M^{T} is the adjoint model, and ΣCΣ^{T} is a static error correlation (C) symmetrically multiplied by the error standard deviation (Σ) that describes the initial condition error or the model error. The VRAM tangent linear and adjoint operators are linked to NCOM-4DVAR as additional observation operators contained within H and H^{T}. In this way the ocean variables of temperature and salinity can be mapped to the acoustic observation space (to be compared to acoustic observations) via H, and acoustic observation information can be passed to the ocean adjoint model via H^{T}. In this present work, no observation assimilation is done; rather the coupled NCOM/VRAM adjoint operator is used to examine the coupled adjoint sensitivity and its implications on data assimilation and adaptive sampling.

### 2.2. Model and Adjoint Sensitivity Experiment Setup

The purpose of the sensitivity study is to determine, for low frequency (50 Hz) and mid-frequency (300 Hz), at what vertical levels the acoustic propagation is most sensitive to the ocean environment temperature and salinity for both long- and short-range cases. This could be determined with VRAM alone; however, in order to quantify the sensitivity to input temperature and salinity either at the location of the environmental profile used by RAM or within the larger space/time ocean model domain, then a fully-coupled adjoint model is required. This sensitivity study also provides insight as to what ocean variables, locations, and times the acoustic propagation is most sensitive to within the larger ocean model domain. This type of information may be helpful in designing an adaptive ocean observation sampling scheme for future applications.

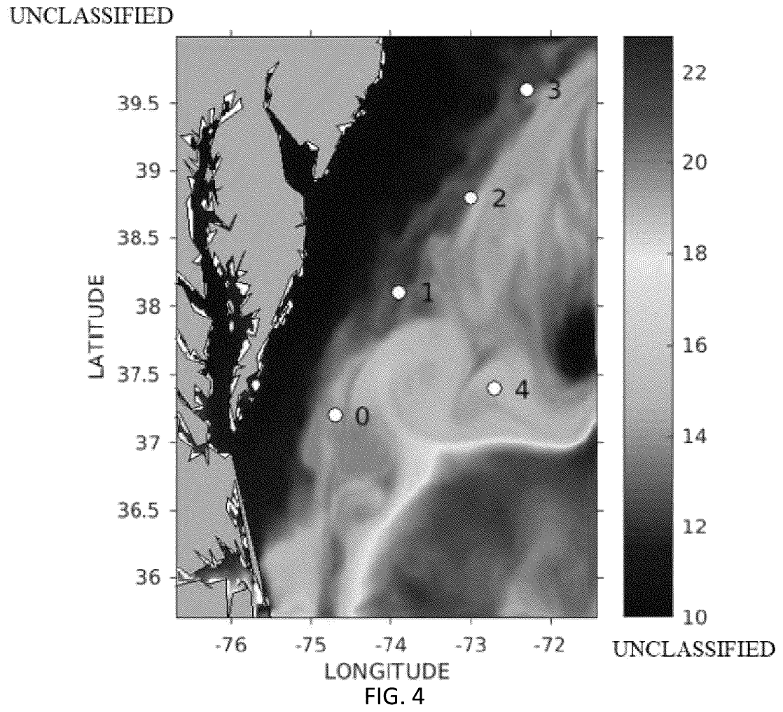

For this study a mid-Atlantic Bight NCOM domain has been configured (FIG. 4). NCOM is a primitive equation model (Barron et al. 2006) that uses a Mellor-Yamada Level-2.5 turbulence closure parameterization (Mellor and Yamada, 1982) for vertical diffusion and the third-order upwind horizontal advection scheme. The model domain for this experiment extends from 71.4°-76.7° W and 35.7°-40.0° N using a spherical coordinate projection at a horizontal resolution of 3 km. The model has 50 layers in the vertical, with 25 free-sigma levels extending to a depth of 116 meters with constant z-levels extending down to a maximum of 5500 meters with the depth of the first subsurface layer at 0.5 m. Lateral boundary conditions are provided by the Navy's Global Ocean Forecasting System (GOFS v3.1) with surface atmospheric forcing, such as wind stress, atmospheric pressure, and surface heat flux provided by the Coupled Ocean/Atmosphere Prediction System (COAMPS©) at hourly intervals (Hodur 1997).

Four short-range acoustic source locations are set within the model domain along the continental shelf break. Each source location has a depth of 50 m with one radial each extending due East for about 2000 m. An additional source location is configured for use as both a mid-range and long-range adjoint sensitivity location. For the long-range radial, the source depth is 50 m and the radial extends due South for 30 km. The NCOM domain with surface temperature on 1 May, 2021 along with the acoustic source locations are shown in FIG. 4. The source locations for the short ranges are arranged south to north along the shelf-break; radial 0 (3) is the Southern (Northern) most location. The long-range source location (labeled as radial 4) is located away from this line and is furthest East. For the short-range cases, given the fact that the ocean model uses a 3 km horizontal resolution, these radials are essentially “range-independent” in that only one sound speed profile is used from the source to the end of the range (e.g., in some embodiments). This is not true for the long-range case, however, as 16 distinct sound speed profiles are used (range-dependent). The adjoint sensitivity study shown here starts on 1 May, 2021 and, using the coupled NCOM-VRAM adjoint model, is run backward for 5 days to 26 Apr. 2021. To generate the sensitivity, each radial is forced with a perturbation near the end of each radial (of unit magnitude) at specific depths (15 to 105 m depth, every 15 meters).

### 2.3. Sensitivity Experiment Results

### 2.3.1 Sensitivity to Acoustic Pressure Back to Source (Short Radials)

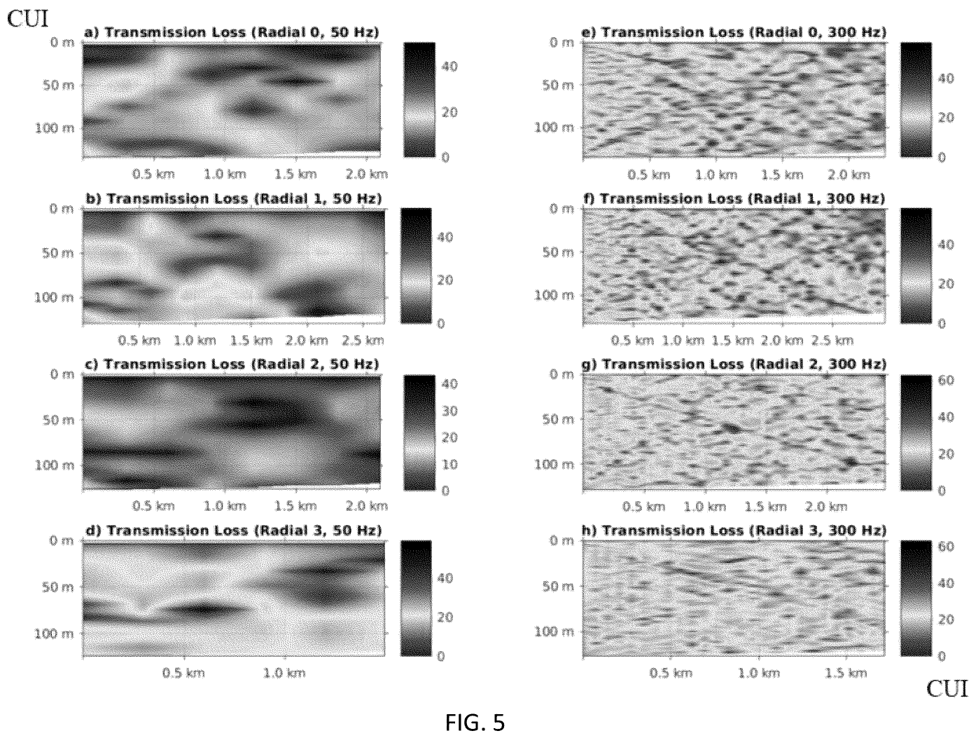

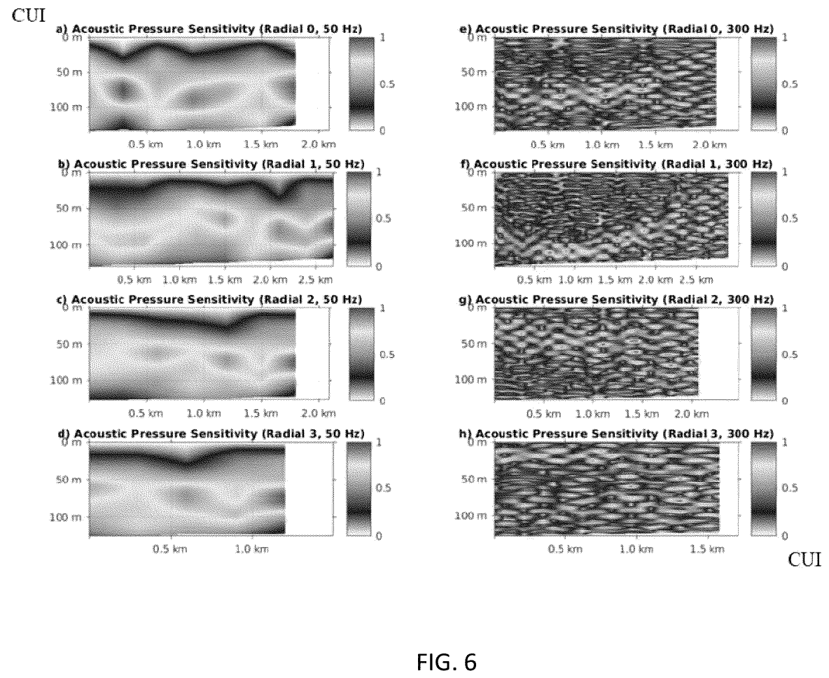

Prior to examining the adjoint sensitivity results, one can look first at the background state of the model. FIG. 5 shows the acoustic transmission loss (TL), in dB, for (a) radial 0 at 50 Hz, (b) radial 1 at 50 Hz, (c) radial 2 at 50 Hz, (d) radial 3 at 50 Hz, (e) radial 0 at 300 Hz, (f) radial 1 at 300 Hz, (g) radial 2 at 300 Hz, and (h) radial 3 at 300 Hz. Given that these are all short radials the acoustic TL is relatively low. For each radial at 50 Hz it can be seen that the features resolved by RAM are very broad and are considerably “larger-scale” in nature. Contrast this with 300 Hz, which exhibits features that are smaller-scale in nature. FIG. 6 shows the adjoint sensitivity of acoustic pressure at the end of each radial to acoustic pressure along each radial and back to the source location; each panel of FIG. 6 corresponding to the same radial and frequency as that shown in FIG. 5. For the adjoint sensitivities shown here, the values have been normalized by the largest sensitivity at each frequency among the radials; overall, the 300 Hz sensitivities have higher magnitudes. At 50 Hz, the adjoint sensitivity (like the TL background field) is vertically broad and smooth. Each radial seems to exhibit a peak sensitivity value generally between the depths of 50 and 100 m. This may be due to the similarities of the TL pattern shared by the four radials, regardless of their position within the ocean model domain. The sensitivity at 300 Hz, on the other hand, exhibits a pattern of magnitude peaks that are horizontally-banded. The maximum sensitivity appears to be at different depths across the radials, unlike what is seen at 50 Hz. This suggests that data assimilation done at the lower frequency (50 Hz) will likely result in broad adjustments to the environmental profiles for this short-radial case. This finding is consistent with other studies that found lower frequency (specifically 75 Hz) acoustics were more sensitive to oceanographic data assimilation than higher frequencies (Storto et al., 2020). However, it cannot be discounted that the higher frequency sensitivity shows strong peaks at specific depths, suggesting a sensitivity to small-scale features in the oceanographic profiles. In that case, assimilating data at both frequencies would provide multi-scale corrections.

### 2.3.2 Sensitivity to Input Temperature and Salinity Profiles (Short Radials)

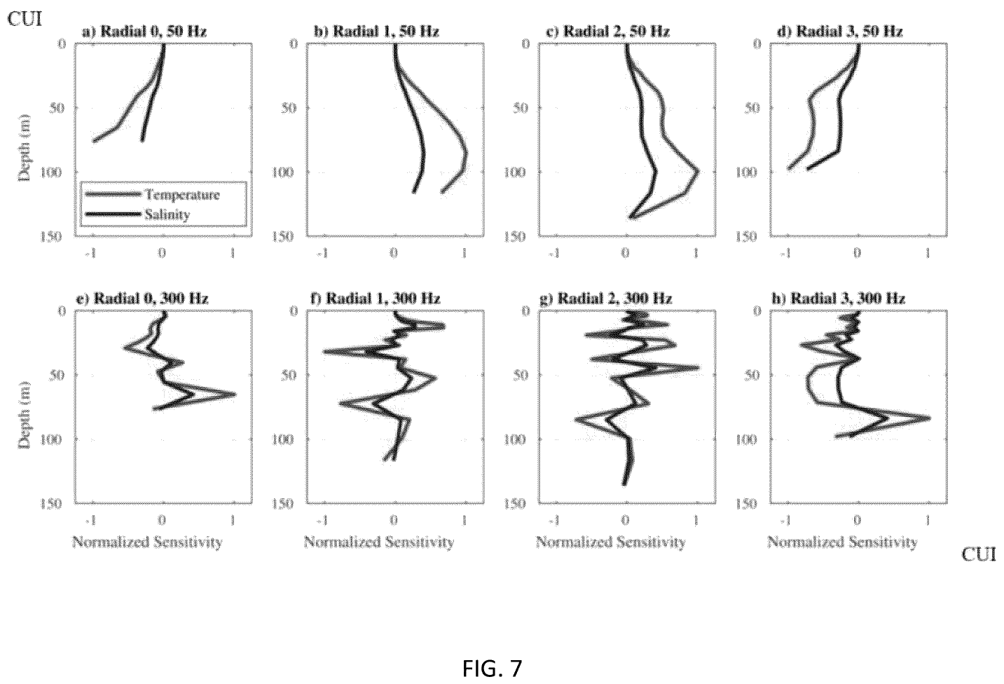

The sensitivity to the input temperature and salinity profiles can also be examined. Here, due to the range-independent nature of the short-range configuration, the acoustic adjoint sensitivity is integrated back to the source location where the adjoint model produces the adjoint sensitivity of acoustic pressure to sound speed. This is further propagated to sensitivity to temperature and salinity via the adjoint of the linearized sound speed equation (Ngodock et al., 2017). FIG. 7 shows this sensitivity to temperature (red line) and salinity (blue line) at each of the four radial locations for 50 Hz (top panels) and 300 Hz (bottom panels). The sensitivity values have been normalized at each radial and frequency so as to compare the magnitudes between temperature and salinity. As suggested by the results shown in FIG. 6, the acoustic pressure sensitivity to temperature and salinity at 50 Hz is vertically broad and smooth, again indicating that the acoustic pressure is almost uniformly sensitive to these oceanographic quantities through this entire 150 m water column. The sensitivity to temperature is higher than that for salinity; this is not surprising as the correlation between sound speed and temperature is higher than that with salinity (Chen and Millero, 1977; Millero and Li, 1994). In an inverse sense, this indicates that if one were to assimilate acoustic pressure measurements to update the ocean model field, then the corrections derived in these cases would produce relatively large-spatial-scale corrections to the entire water column down to 100 m depth or so. Contrast this with the results seen at 300 Hz where, again, the sensitivity is rather “jagged” in appearance. This does continue to suggest that the higher frequency observations tend to carry information regarding the small-scale structure more so than at 50 Hz.

### 2.3.3 Sensitivity within the Larger Ocean Domain (Short Radials)

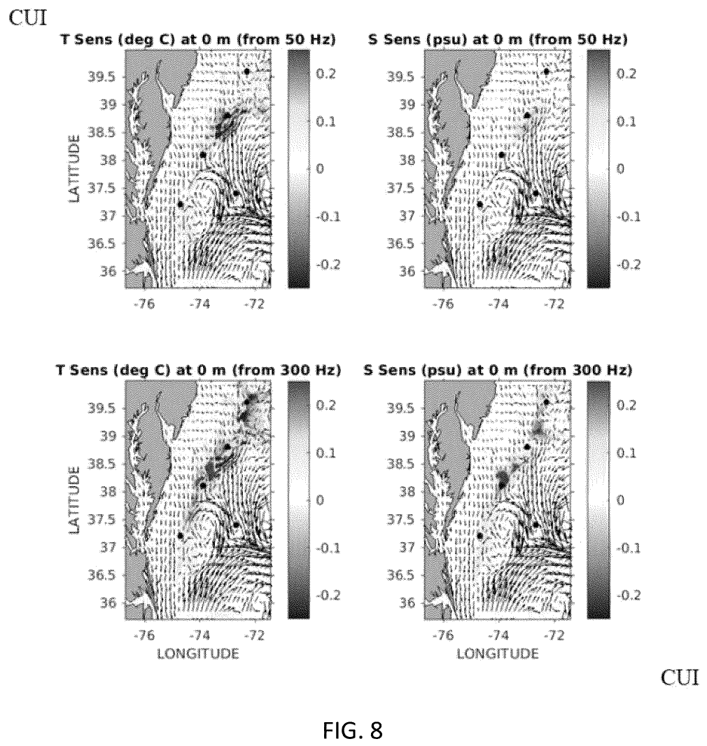

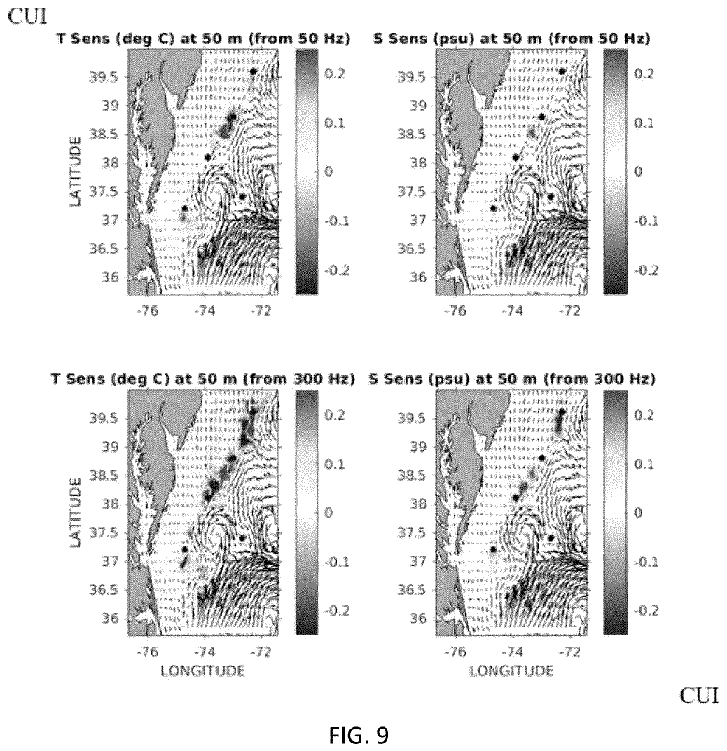

The spatial extent of the adjoint sensitivity of acoustic pressure to the ocean model temperature and salinity can be examined by mapping the sensitivity (in temperature and salinity) across the NCOM domain at some representative depths, e.g. the surface and 50 m. FIG. 8 shows the sensitivity of acoustic pressure to temperature (left panels) and salinity (right panels) at the surface for 50 Hz (top panels) and 300 Hz (bottom panels) after 120 hours of adjoint model integration (valid 0 z, 26 Apr. 2021 for an analysis at 0 z 1 May 2021); the location of each radial source is indicated by the black dots and the background model currents are shown as arrow vectors. The magnitude of the sensitivity is higher at 300 Hz than at 50 Hz, which explains why higher sensitivity values project further from the source locations than at 50 Hz. The sensitivity maps are similar, however, in terms of where the acoustic pressure is sensitive to. At both frequencies, the sensitivity appears to stretch along the shelf-break, following the currents in the background state model. In both cases this extends the sensitivity farther south (to about 36° N) and more than 100 km away from the southern-most radial location. In addition, the adjoint model is also propagating the sensitivity to the East at about 39° N in response to a westward-moving current in that region. FIG. 9 shows the same information as FIG. 8, but for 50 m depth. At this depth the sensitivity seems to stay rather confined to the shelf break area, although the sensitivity still extends to the East at 39° N like at the surface, again due to currents in that region. This result shows that, if one were to assimilate acoustic pressure measurements at these locations, the information gained from those observations would impact the ocean model far from the area of the radial itself, even at 50 Hz. Also, the adjoint sensitivity can be used to inform observation sampling strategies as well. If one were concerned with accurate acoustic propagation modeling at particular sites, one could use this adjoint approach to determine where (and when) to seed the ocean with profiling floats and/or gliders in order to provide the ocean model with the necessary constraining observations. Given the rather under-sampled nature of the ocean for modeling purposes, and the cost of observing platforms (in materials, ship time, manpower, etc.), knowing where and when to sample for observations becomes a powerful tool. The accuracy of this approach is highly dependent on the accuracy of the background model solution, particularly the flow field. How robust this approach is, with varying degrees of background model accuracy, still needs to be investigated in future studies.

### 2.3.4 Sensitivity to Acoustic Pressure Back to Source (Long Radials)

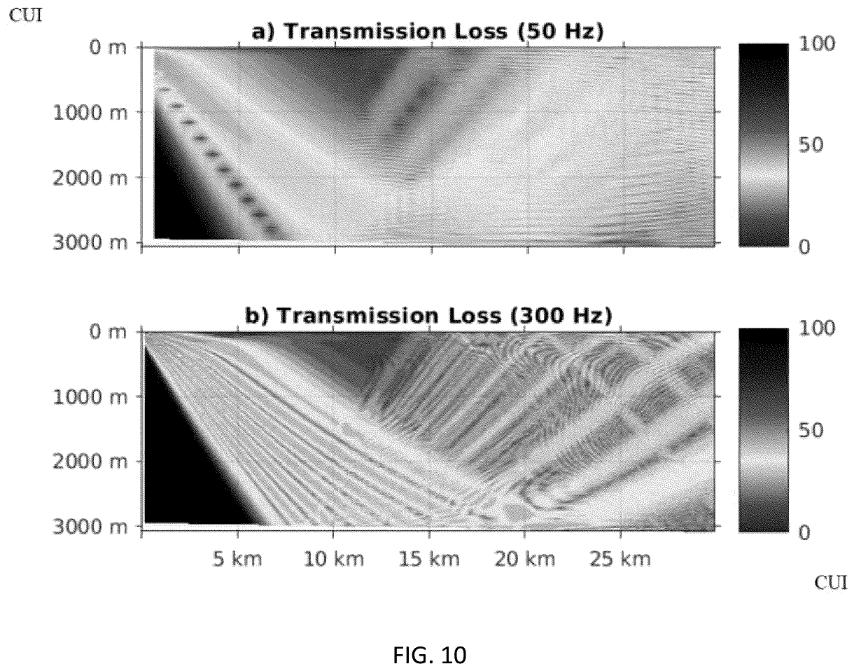

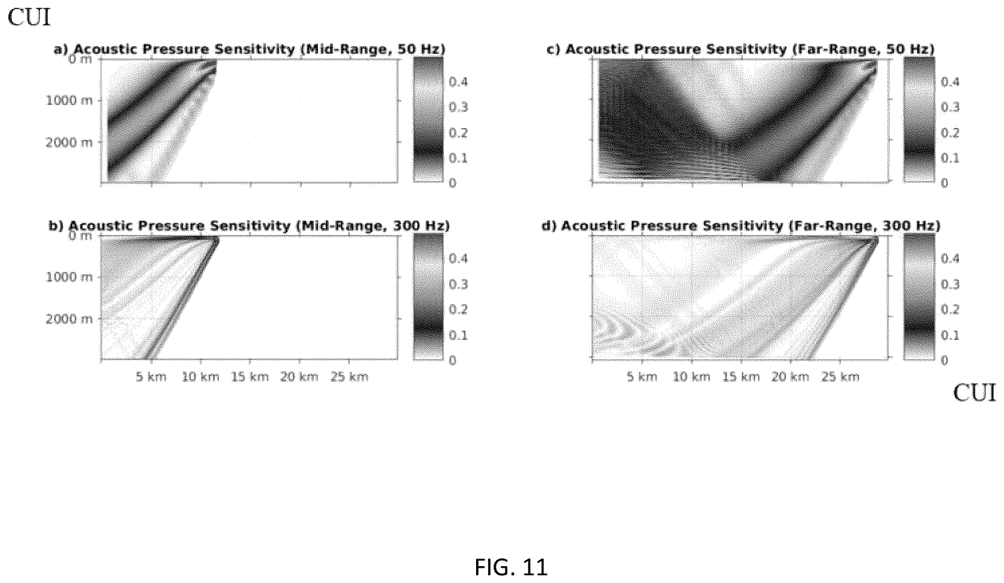

The behavior of the acoustic pressure and its sensitivity to acoustic pressure in range as well as temperature and salinity for long-range cases can be explored. To examine this, a separate coupled ocean-acoustic adjoint model is run using the aforementioned fifth source location (furthest East position in FIG. 4). FIG. 10 shows the TL at 50 Hz (top panel) and 300 Hz (bottom panel) from this source location out in range to 30 km. The TL is very similar between the two frequencies, albeit with smaller-scale structure at 300 Hz. The sound propagation is refracted downward from the source location to a depth near 3000 m where it interacts with bottom topography and reflects back toward the ocean surface. At both frequencies, the TL is relatively high (75 dB) nearer the surface at a range of about 12 km. We have seen from the short-range cases that the adjoint sensitivity of acoustic pressure to temperature and salinity is uniformly distributed in the vertical (FIG. 6, smoothly for 50 Hz and in a more jagged fashion at 300 Hz). Given the TL for this long-range case it would seem that, if the adjoint model were initialized at similar depths but at 30 km, the sensitivity of acoustic pressure to temperature and salinity should peak at various depths depending on the range of the environmental profile (regardless of frequency). Given this TL pattern there is a question of what the sensitivity field will be if the adjoint model is initialized with a perturbation within the high-TL region. To examine both of these concepts, FIG. 11 shows the adjoint sensitivity for 50 Hz (top panels) and 300 Hz (bottom panels) when the adjoint model is initialized with a perturbation at mid-range (at 12 km, left panels) and long-range (at 29 km, right panels); values in this case are not normalized. In both the mid-range and long-range cases, the acoustic sensitivity out in range is highly range and depth dependent based on the position of the TL waveguide. The sensitivity magnitude is highest near the initialization point and tends to drop-off back towards the source (especially for the long-range case). For the long-range cases (FIG. 11, c and d), the adjoint sensitivity pattern resembles a minor image of the forward model TL solution. Most of the high-sensitivity values are restricted to within the waveguide and are highest out in range and near the source depth of the initial acoustic pressure profile. In the case of the mid-range sensitivity (FIG. 11, a and b), where the adjoint forcing is placed in an area of high TL (see FIG. 10), the sensitivity pattern is high from the forcing location back to 2000 m depth at the source profile location. This shows that the 12 km region of this range/depth plane is highly sensitive to the initial acoustic pressure profile at 2000 m depth. If this were a data assimilation application, and the model-observation innovation was large near the surface at 12 km range, the result would be to strongly adjust the initial acoustic pressure profile at 2000 m depth. This indicates that the background model solution has substantial error. If there was high confidence in the geographic location of the source, but not the depth, then the assimilation of data in this case may help to isolate the source depth and adjust the background model accordingly.

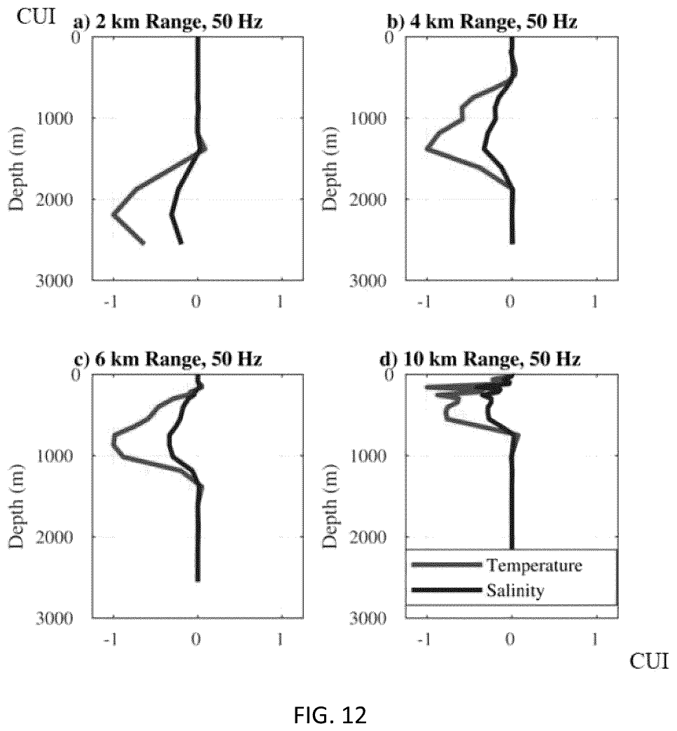

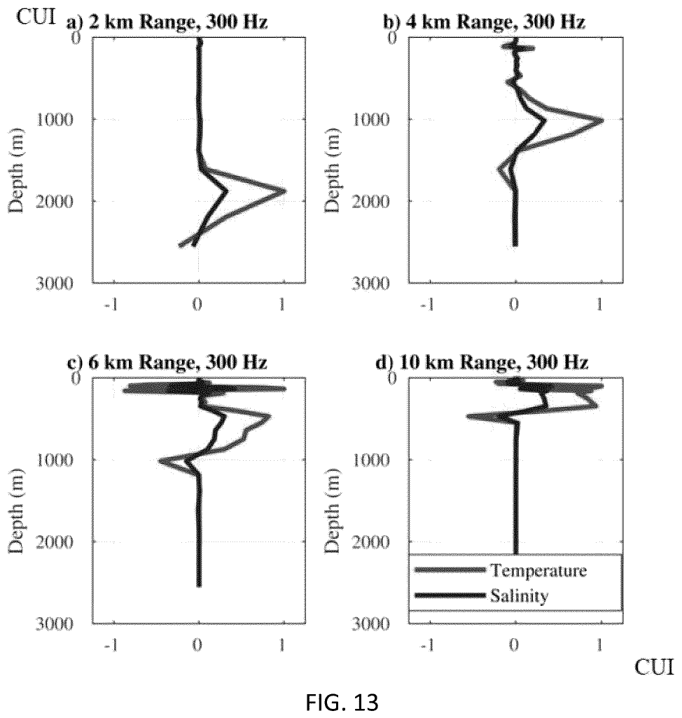

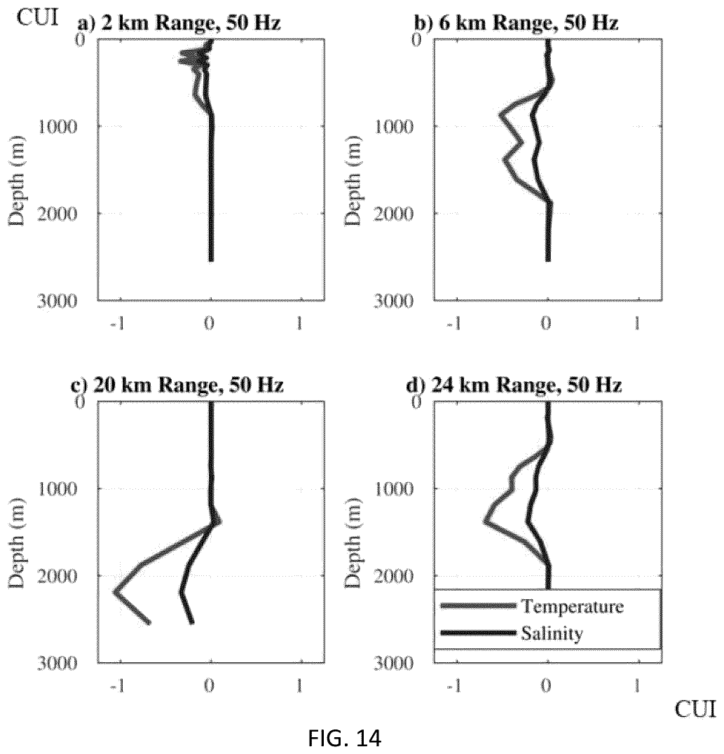

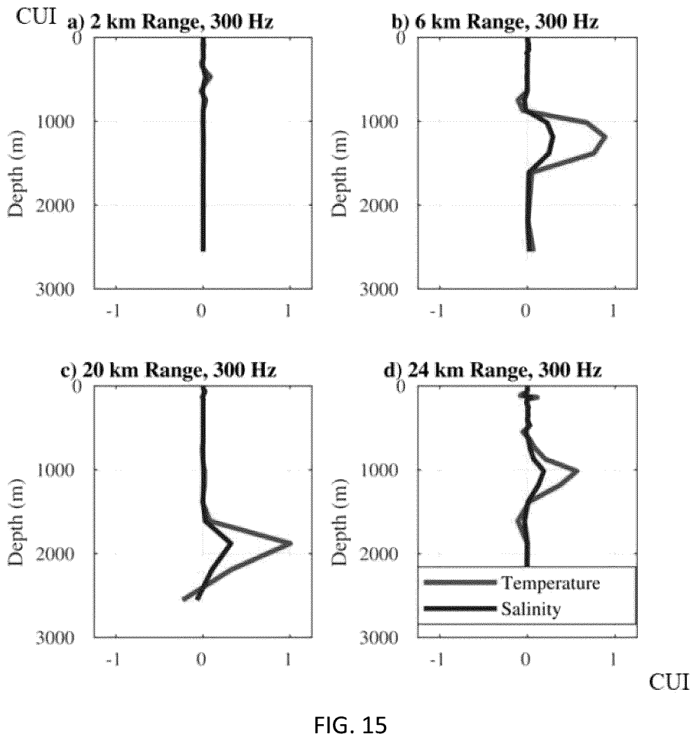

Examining the acoustic pressure sensitivity to temperature and salinity at selected locations in range will help to determine if there is a strong range and depth dependence in these fields as well. FIG. 12 shows the acoustic pressure sensitivity to temperature (red line) and salinity (blue line) at 50 Hz for the mid-range case at (a) 2 km range, (b) 4 km range, (c) 6 km range, and (d) 10 km range; values are normalized by the highest sensitivity value (either temperature or salinity) across all profiles. It can be seen from this result that the sensitivity to temperature and salinity follows the same range and depth dependence as was seen in FIG. 11. In this mid-range case can also be seen that, like the short-range cases, the temperature field exhibits the highest overall sensitivity values. Also, the sensitivity value is almost the same magnitude from the adjoint initialization point (12 km) back to the source profile. The same conclusions can be drawn from FIG. 13 (same as FIG. 12, but for 300 Hz), although in this case the highest sensitivity magnitude is roughly one-third of that seen at 50 Hz. For 50 Hz in the long-range case (FIG. 14) the same range and depth dependence occurs, however, the magnitude of the sensitivity is also range-dependent. Those profiles closer to the adjoint initialization point (29 km) exhibit higher sensitivity magnitudes than those nearer the source location; the same is true for 300 Hz as well (FIG. 15). This suggests that the environmental profiles nearer to the observation location would be strongly corrected in a data assimilation application, whereas those closer to the source location would be impacted less.

### 3.0 The Assimilation of Simulated Acoustic Pressure Observations and Their Impact on the Ocean Model Analysis and Forecast

There is a fair amount of research that has been devoted over the years to utilizing ocean acoustic measurements, of one form or another, to gather information on ocean temperature and salinity. A great deal of this work has focused on acoustic tomography. The use of acoustic tomography for measuring ocean properties was postulated by Munk and Wunsch (1979) and examined in numerous works since then. The basic idea behind acoustic tomography is to conduct an inversion for environmental sound speed by minimizing the difference between modeled and measured acoustic travel times. Cornuelle et al. (1985) conducted an experiment comparing the tomography-derived sound speed environments to in-situ measurements and found strong correlation between them. Skarsoulis and Send (2000) examined the use of acoustic tomography in the presence of strong nonlinear dependency between sound speed and acoustic travel time variations. And a more recent study by Dushaw (2019) examined the impact of ocean acoustic tomography in combination with Argo floats. Dushaw found that each observing type, when utilized in isolation, is capable of reducing the uncertainty in large-scale monthly average temperature by about 50%; however, when used together the uncertainty is reduced by about 75%.

Acoustic pressure assimilation, however, is different than acoustic tomography in that rather than examining the difference in acoustic travel times between modeled and measured values, acoustic pressure assimilation involves differencing the recorded pressure (as captured by hydrophones) with modeled values. Typically, acoustic pressure is modeled using some form of a parabolic equation-based approach, such as that used in the Navy's Range-dependent Acoustic Model (RAM; Collins et al., 1996). These models use information regarding the sediment conditions, the surface wind and wave state, and the environmental sound speed. The use of variational techniques in assimilating acoustic pressure observations has been examined in previous studies. Most notably by Hursky et al. (2004) where the tangent linear and adjoint of a parabolic equation model is derived and used to assimilate acoustic pressure measurements in order to adjust the assumed sound speed profile. And yet other published studies examine various aspects of acoustic pressure assimilation (Hermand et al., 2006; Le Gac et al., 2004; Charpentier and Roux, 2004). A more recent study by Storto et al. (2021) used a neural-network based observation operator in order to perform coupled ocean-acoustic data assimilation with simulated observations. They found that both methods employed (canonical correlation analysis and neural-networks) were able to improve the skill score of the assimilative model. This present work takes a similar approach where the goal is to improve the ocean state estimation and short-term model forecast via the assimilation of acoustic observations; the novelty is that the adjoint and tangent linear of RAM (referred to as Variational RAM, or VRAM) are integrated as observation operators within the larger Navy Coastal Ocean Model (NCOM) 4DVAR assimilation system. With that, the impact of acoustic pressure observations on the ocean analysis and forecast can be examined.

One or more aspects described herein examine the coupled ocean-acoustic adjoint sensitivity from four short-distance range/depth planes (or radials) and one long-distance radial within an NCOM domain of the Mid-Atlantic Bight in May, 2021. The lessons learned from that study have helped to form this first proof-of-concept test of the assimilation capabilities of the coupled ocean-acoustic 4DVAR using NCOM and RAM. In this present work, simulated acoustic observations collected near the end of each of the four short-distance radials presented (at 50 Hz) are assimilated and the impact of these observations is examined both at the analysis time and also within the subsequent 24-hr forecast. The choice of short radials and observations simulated at 50 Hz is made based on the findings of the aforementioned adjoint sensitivity analysis, which determined that the sensitivity of the acoustic pressure to input ocean temperature and salinity is vertically broad and nearly uniform within the water column. This suggests the likelihood of strong correction of the ocean model using this configuration.

The presentation of the models (NCOM and RAM) and the data assimilation algorithm (NCOM-4DVAR and VRAM) are described.

### 3.1 Model Setup and Observation Sampling

The OSSE performed for this work utilizes the NCOM model to generate both the nature run (NR, the proxy for the “true” ocean state) and the simulated ocean. The NR is configured for a 1 km horizontal resolution with 100 vertical levels. The model domain extends from 71.4°-76.7° W and 35.7°-40.0° N using a spherical coordinate projection. The NR model is initialized on 1 Mar. 2021 and run through 31 May, 2021; in this case the first two months (March and April) are used in order to spin-up the model state and observations are sampled using output from May only. The simulated ocean, on the other hand, uses a 3 km horizontal resolution with only 50 vertical levels. This degradation in both horizontal and vertical resolution is meant to capture some of the representation error that ocean models typically suffer from due to computational limitations. Both the NR and simulated ocean models are initialized from the Navy's Global Ocean Forecasting System (GOFS v3.1). The NR uses GOFS output from 1 Mar. 2021 for its initialization, whereas the simulated ocean model uses GOFS output from 1 Apr. 2021. In order to enhance the differences between the two models, however, the simulated ocean model initial condition field is positioned at 15 Apr., 2021 (a time shift) in order to increase error relative to the NR. Both models, however, use lateral boundary conditions from GOFS (with no adjustment) and surface forcing, such as wind stress, atmospheric pressure, and surface heat flux, from the COAMPS© model at hourly intervals (Hodur 1997). The models are compared to each other, through time, from 1 to 31 May, 2021; with the simulated ocean model either as a free-run (FR, no data assimilation) model or as a data assimilative run (AR).

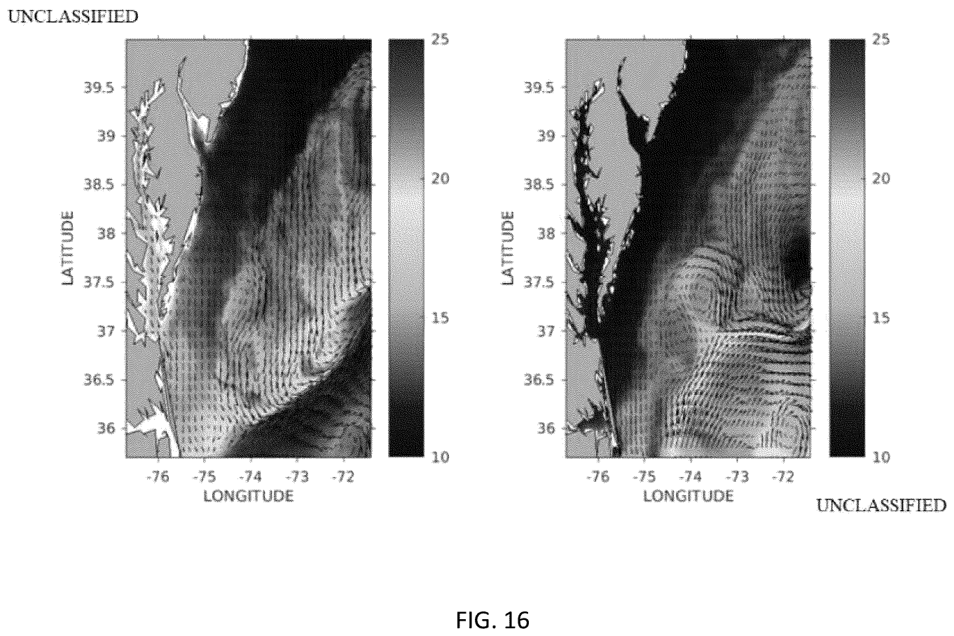

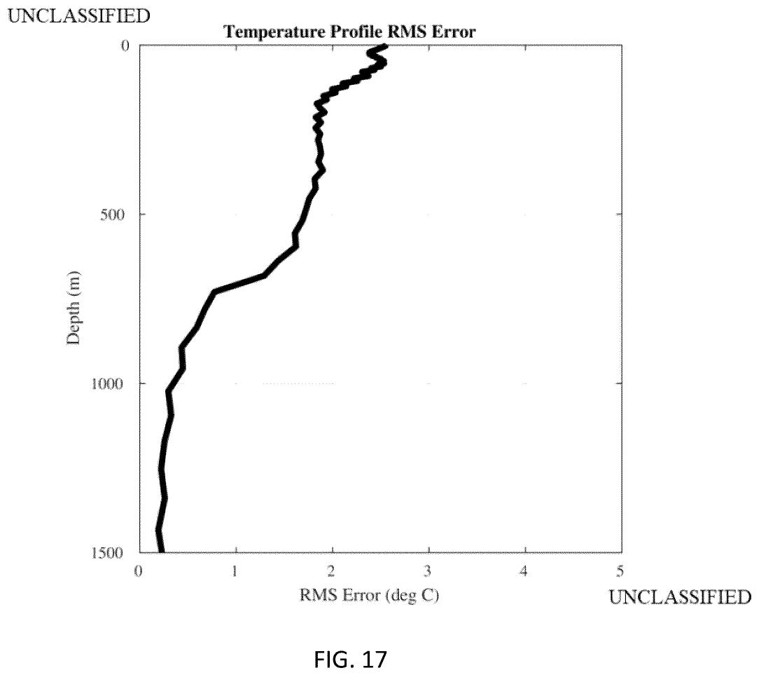

FIG. 16 shows the sea surface temperature (SST) of the NR (left panel) and the FR (right panel) on 1 May, 2021, with the ocean currents overlaid as arrow vectors. The difference in horizontal resolution can be seen, as the NR exhibits smaller-scale features embedded within the larger-scale flow, whereas the features shown in the FR are much smoother. The models are largely divergent due to the difference in the initial condition and spin-up run times. The Gulf Stream flow is very different between the two models, with a more Northerly extent of the current between 73° to 74° W in the FR relative to the NR. Also, the FR exhibits much lower SSTs within the Gulf Stream than is shown in the NR. Both models exhibit a cold-pool of water extending from the model's Northern boundary along the coast; although, the FR shows colder temperatures in this region than the NR. Regardless of the differences, however, both models are qualitatively simulating the known features within this domain during this time of year accurately. FIG. 17 shows the temperature profile averaged root mean square error (RMSE) between the NR and FR from 1-31 May, 2021 across the entire shared model region. The error peaks near 2.5° C. near the surface and stays between 1.5° to 2° C. for most of the average thermocline region (˜250 to 700 m depth). These errors are slightly high for NCOM within this region, as compared to operational model runs produced by the U.S. Navy's Fleet Numerical Meteorology and Oceanography Center (FNMOC), however they are deemed acceptable as the high error should help to accentuate positive gains brought via the data assimilation of acoustic observations.

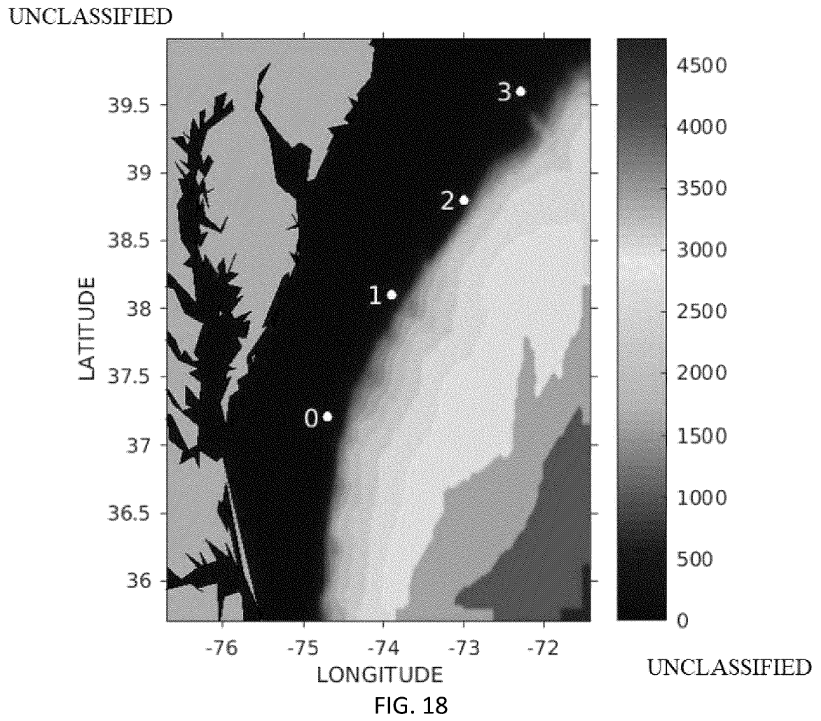

In order to sample the NR for acoustic observations, four short-distance radials are configured using four acoustic source locations within the NR domain. FIG. 18 shows the NR bathymetry (color contours) as well as the four source locations within the domain (white dots), numbered 0 through 3. Each source is assumed to have an acoustic source depth of 50 m and a frequency of 50 Hz. RAM is used to generate the acoustic pressure values along a two-dimensional range/depth plane (the aforementioned “radials”) using the NR to provide the required sound speed profiles (derived from the NR temperature and salinity). Each source location has one radial pointing due East by about 2 km. Each radial is configured to be range-independent, which interpolates the nearest model environmental profiles of temperature and salinity to the source location to compute the input sound speed profile; this sound speed profile is then used for the entire radial (herein referred to as the environmental profile). This is an acceptable approximation due to the short distance of each radial and the horizontal resolution of both the NR and simulated ocean models. In order to simplify the assimilation experiment, the NR and the various simulated ocean models run RAM with the same geoacoustic bottom and a no-wind surface condition. This can allow for isolating the error in the model simulation to be due purely to the ocean environment.

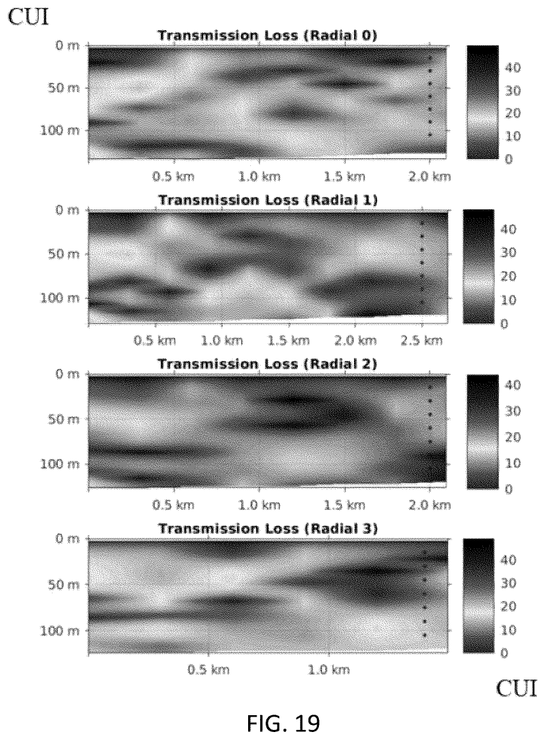

FIG. 19 shows the NR RAM transmission loss (TL, in dB) at 0 z on 1 May, 2021 for radials 0 through 3. The location of the simulated vertical line array for acoustic pressure observation sampling is shown in FIG. 19 by the black dots near the end of each radial. The observations are sampled from 15 to 105 m depth, every 15 m, a similar configuration to Storto et al. (2021). The location of the vertical line array and each source are fixed in time from 1-31 May, 2021 and only one set of observations is recorded along each vertical line array daily (each day at 0 z). The TL pattern at 50 Hz along each radial is very smooth with very little acoustic transmission loss. The lower frequency sound should provide smooth, larger-scale vertical adjustments to the oceanographic temperature and salinity fields (Carrier et al., 2022; Storto et al., 2020).

For the experiments presented here, the NCOM-4DVAR is configured with a 24-hr assimilation window using the strong-constraint option. Initial condition errors are generated by the Navy Coupled Ocean Data Assimilation (NCODA) system (Cummings and Smedstad 2013) using the Generalized Digital Environmental Model (GDEM4) climatological database (Carnes et al., 2010). The 4DVAR analysis is run every 24-hrs, and a 24-hr forecast is generated from each analysis. Acoustic pressure observations are sampled from the nature run at the time of the analysis (at the end of each assimilation window at Oz) during each analysis/forecast cycle.

### 3.2. Results

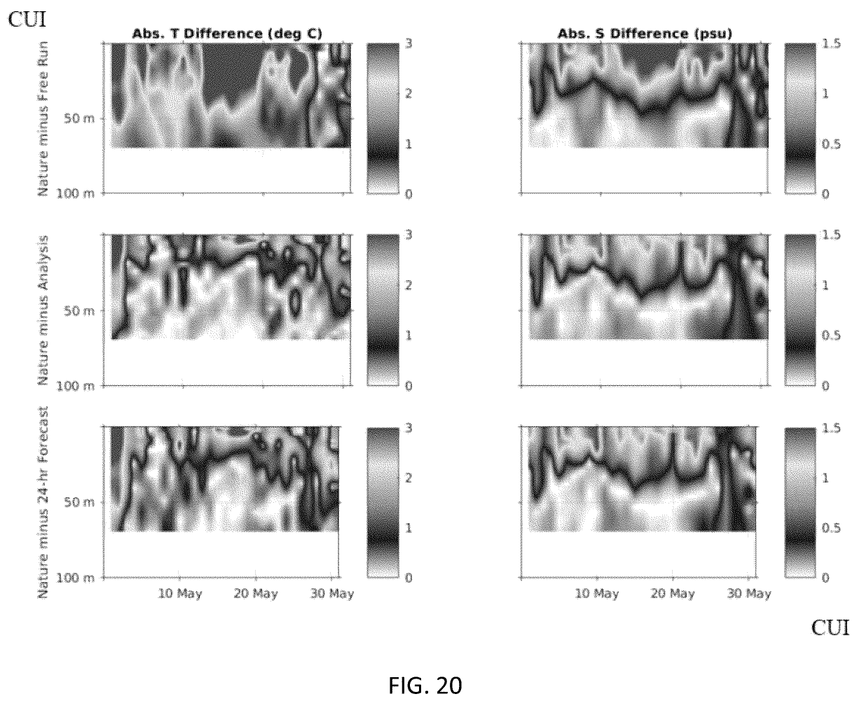

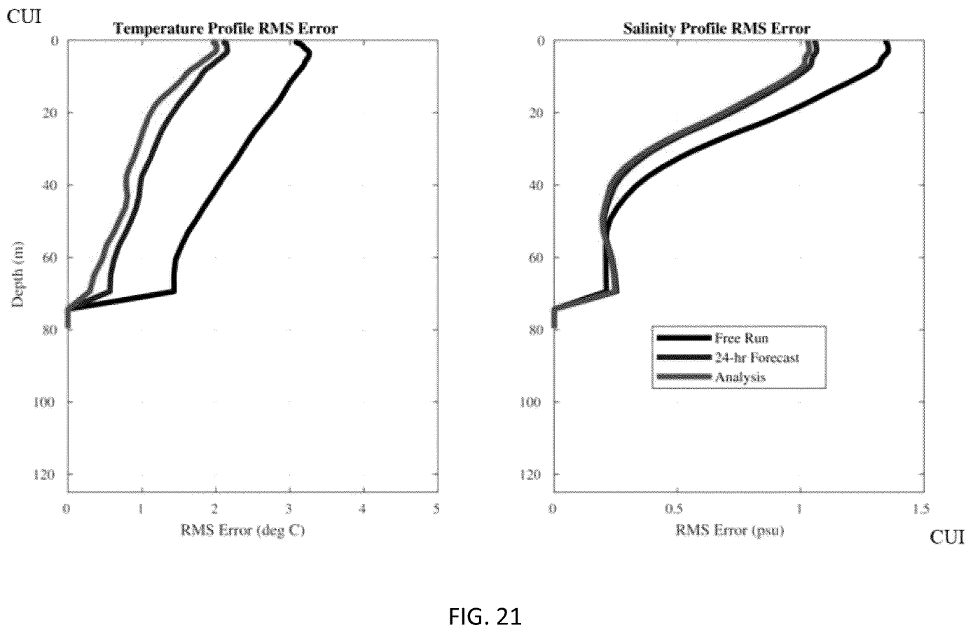

As mentioned previously, the four acoustic radials used in this study are short-range (˜2 km each) and range-independent. Due to this, the correction to the ocean model temperature and salinity at the location of the environmental profile used by RAM and the VRAM operators can be examined. In this case, each profile from the AR at 0-hr (i.e. the analysis) and 24-hr forecasts during each analysis/forecast cycle is compared to the NR profiles. In the case of the 24-hr forecast, the first profile comparison (1 May, 2021) is an uncorrected forecast state. All subsequent 24-hr forecast profiles, however, are the forecast from the data assimilative analysis; therefore, we can compare these fields to the FR state as well. This comparison will show whether the acoustic observations are having a positive impact on the ocean model profiles at these locations and whether this improvement is maintained into the forecast step. FIG. 20 shows this comparison for the environmental profile used for radial 0, as the absolute difference between the NR profile and the FR (top panel), analysis (middle panel), and 24-hr forecast (bottom panel) for temperature (left panels) and salinity (right panels); the differences are shown as a contour plot with the y-axis and x-axis representing depth and time (days in May 2021), respectively, with color showing the difference magnitude. The top-left panel, showing the NR-FR temperature difference, exhibits error higher than 3° C. for most days down to a depth of 50 m. This error stays relatively high in the analysis field (middle panel) initially, but by 3 May the error magnitude has dropped significantly to less than 1° C. from near the surface to the bottom of the water column. The error stays relatively low in the analysis at all depths and subsequent dates, save for some higher error just before 20 May near the surface. Overall, however, the error in the analysis is generally lower than the FR at all dates and depths. The temperature difference in the 24-hr forecast field (bottom panel) looks very similar to that seen in the analysis after the first analysis day (when the largest correction is made), indicating that the forecast model is able to maintain the improvement brought by the data assimilation, at least through the 24-hr forecast time period. The salinity results (right panels) are not nearly as impressive as the temperature, as both the analysis and 24-hr forecast fields maintain relatively high error above 50 m depth at nearly all dates. There is some slight drop in error, but not as much as what is shown in the temperature field. The adjoint sensitivity study results demonstrated that the sensitivity magnitude is higher in temperature than salinity. This result is a consequence of the acoustic pressure not being as sensitive to salinity as to temperature. When the overall root mean square error (RMSE) result is shown at this profile location, in FIG. 21, the drop in error magnitude for both the analysis and the 24-hr forecast from that seen in the FR can be seen for temperature, but can be seen more for salinity, as the error near the surface drops by nearly 0.4 psu.

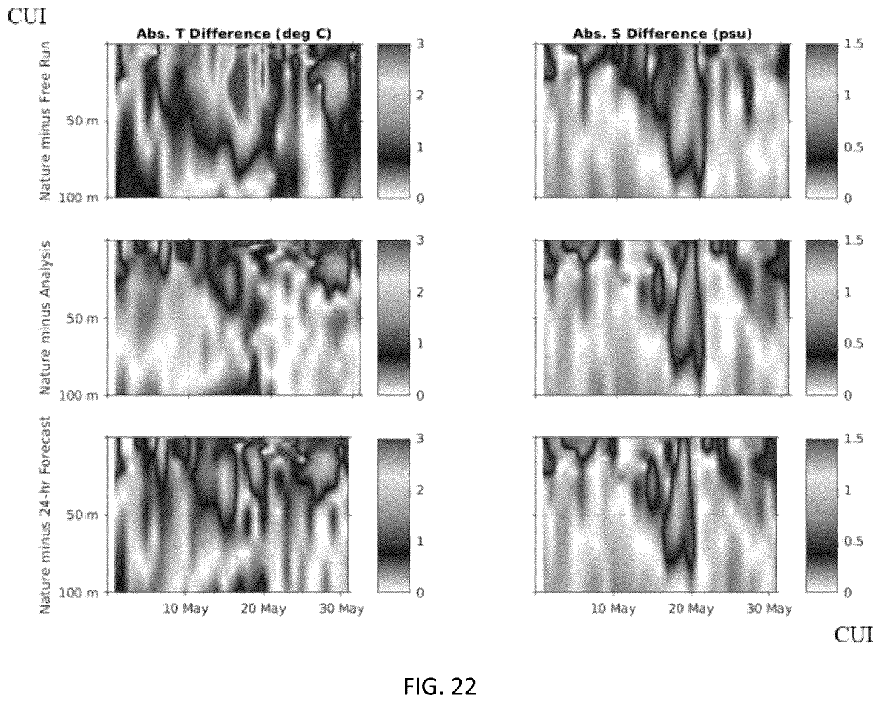

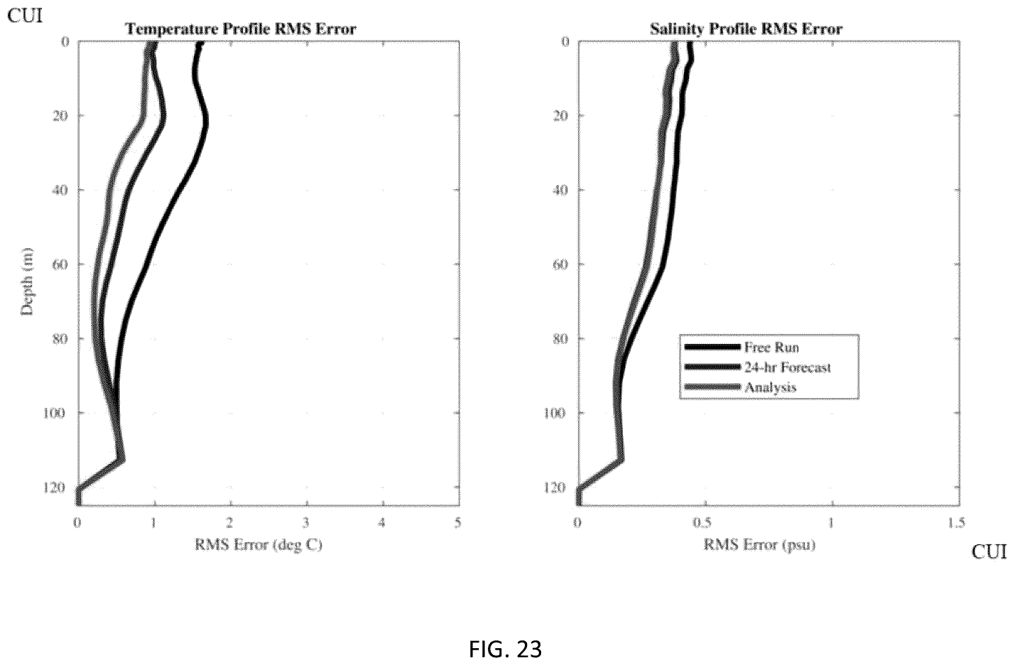

Examining the results at radial 1 (FIG. 22) shows an even better match between the 24-hr forecast/analysis and NR than in radial 0. Here the FR error peaks between 10-20 May with values near 3° C.; this error drops well below 2° C. in the 24-hr forecast and nearly below 1° C. in the analysis. The salinity error also exhibits a reduction in error as well, but again, not as significant as what is seen in temperature. FIG. 23 shows the overall RMSE, this time showing a lower error in the analysis than the 24-hr forecast in temperature, and both lower than the FR. Again, the overall error in salinity is lower, but the correction is not as significant.

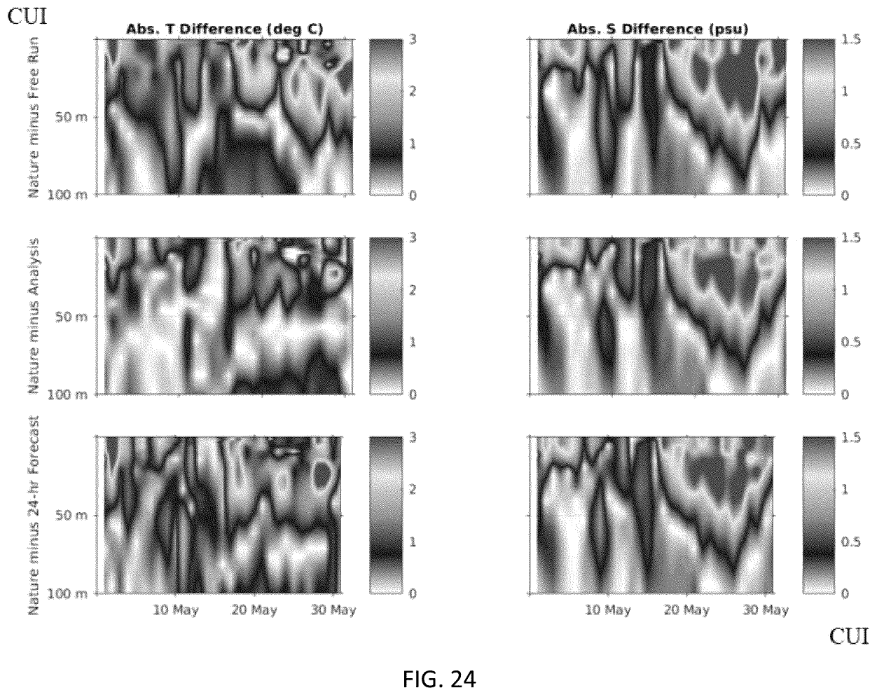

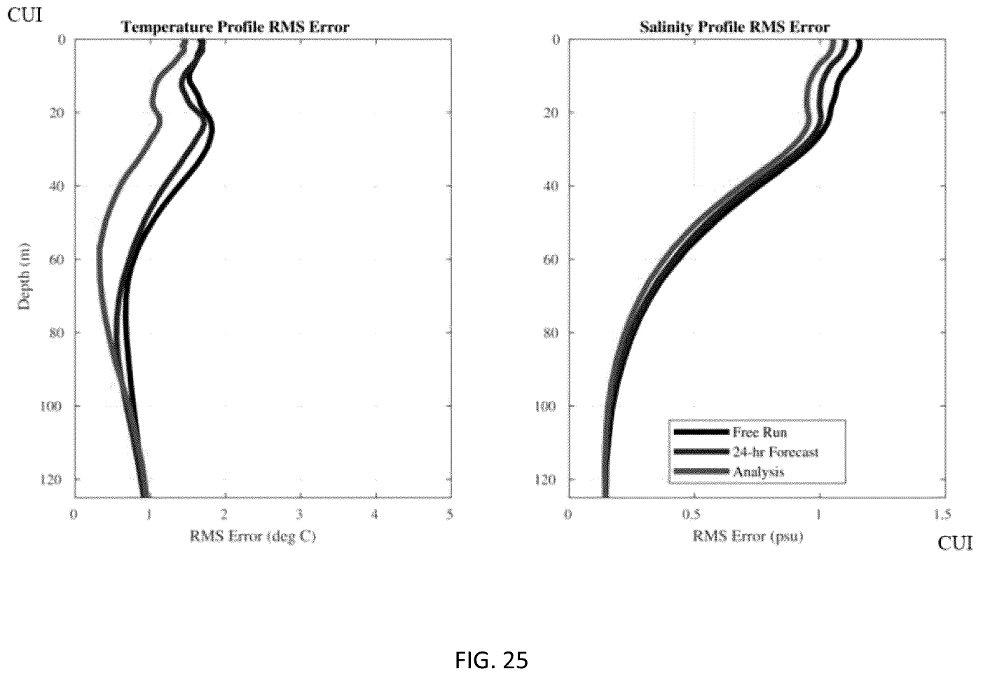

The absolute difference at radial 2 is shown in FIG. 24 with the overall RMSE in FIG. 25. Unlike the first two radials, the drop in error for the 24-hr forecast/analysis compared to the FR is not as significant, even in temperature. The error in the analysis field still exhibits values above 2° C. at certain days above 50 m depth; although the error is lower than that seen in the FR. FIG. 25 shows that the overall RMSE in the analysis is, indeed, lower than that from the FR, but the 24-hr forecast does not maintain this improvement nearly as well as seen at radials 0 and 1, with its overall RMSE value very near that of the FR.

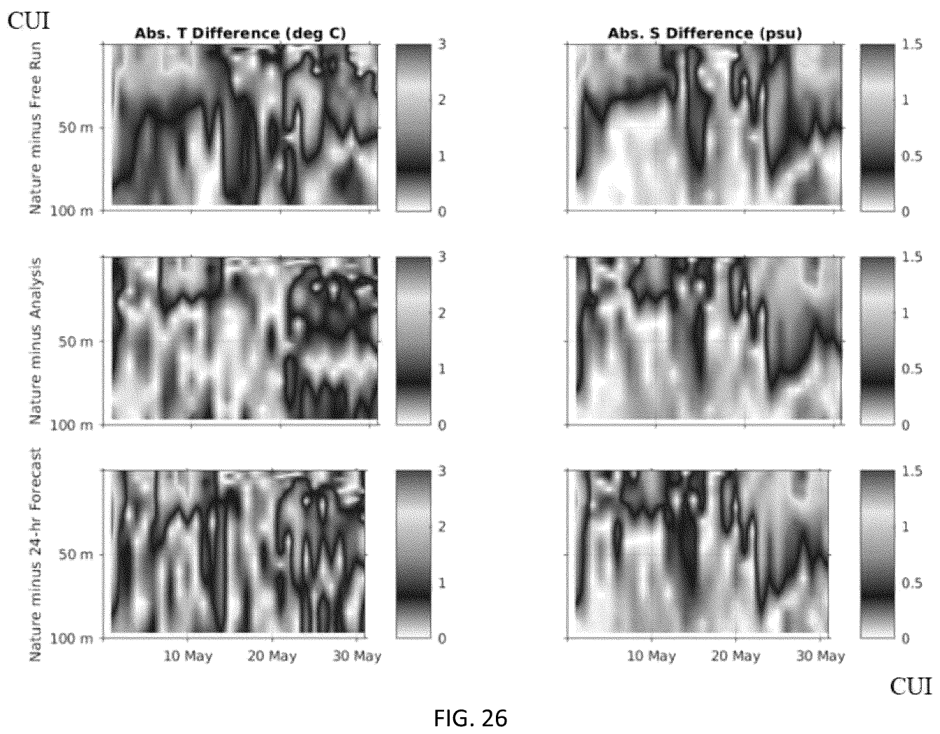

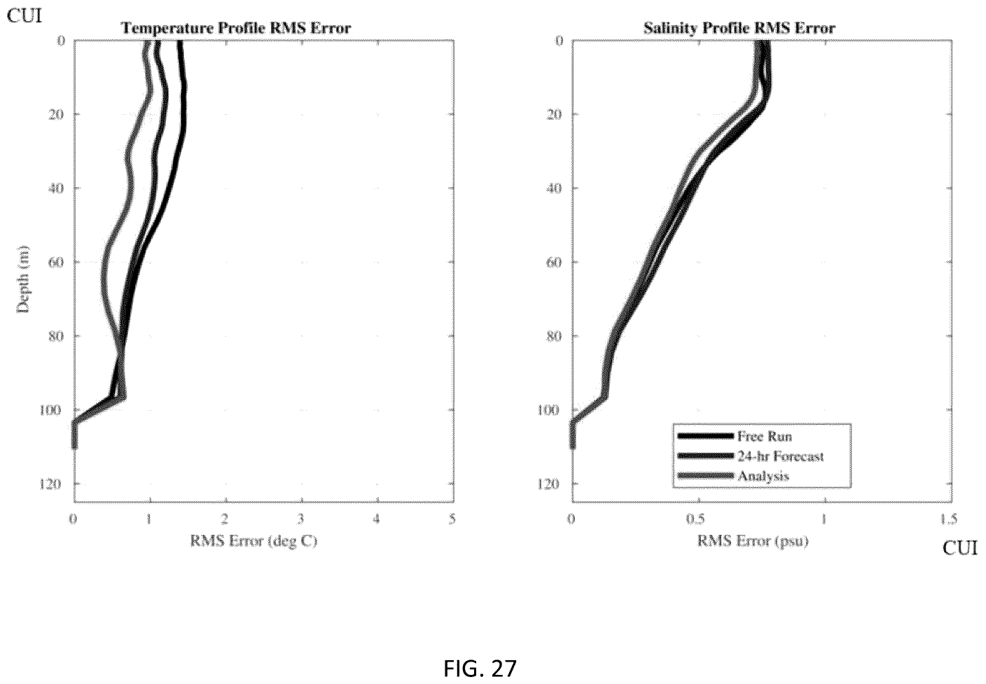

The results are once again largely positive when examining the next radial, radial 3 (FIG. 26). The difference values drop from the FR to the 24-hr forecast field, especially above 50 m across all days; the difference is even greater when examining the analysis field as expected. The salinity results are better for the 24-hr forecast and analysis compared to the FR for the first 20 days of May; however, the results are a bit worse during the last 10 days of May, especially above 50 m depth. The overall RMSE metric (FIG. 27), shows the good performance of the 24-hr forecast and the analysis relative to the FR for temperature, but does exhibit relatively poor performance in salinity, as the 24-hr forecast error is slightly higher for a few locations in depth. Overall, however, the results from radials 0 through 3 indicate that the acoustic observation assimilation is having a net positive impact on the analysis at the location of the environmental profile and that this improvement is carried forward in the first 24-hrs of the forecast period.

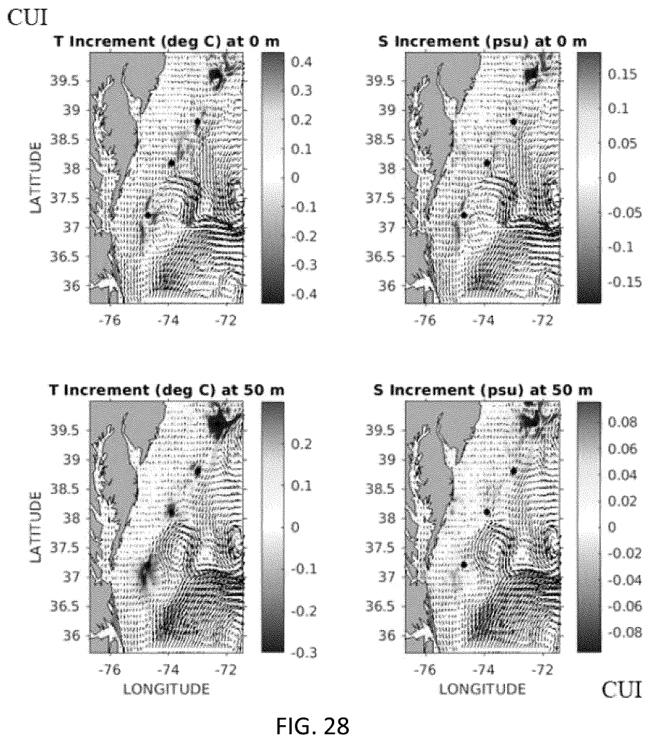

It is likely that the spatial extent of the correction from acoustic observations during the analysis period extends well beyond the environmental profile used at each source location, given that the improvement gained in the analysis step is maintained during the first 24-hrs of the forecast. To examine this, the two-dimensional map of the analysis increment on 1 May, 2021 is shown in FIG. 28. Here, the temperature (left panels) and salinity increments (right panels) are shown at the surface (top panels) and 50 m depth (bottom panels), with each of the four acoustic source locations displayed by black dots and the background forecast currents displayed as arrow vectors. The correction obtained from the acoustic observations produces elongated and flow-dependent corrections due to the four-dimensional background error covariance modeled by the ocean tangent linear and adjoint models. For this analysis, the largest correction in temperature (˜1° C.) appears to occur northeast of radial 3 near the surface, while the broadest spatial extent correction surrounds radial 1 at 50 m depth. Overall, however, most of the model domain still exhibits little correction and is statistically very similar to the FR. This is likely because this experiment only uses four observation locations, a very small amount given the size of the domain (e.g., in some embodiments).

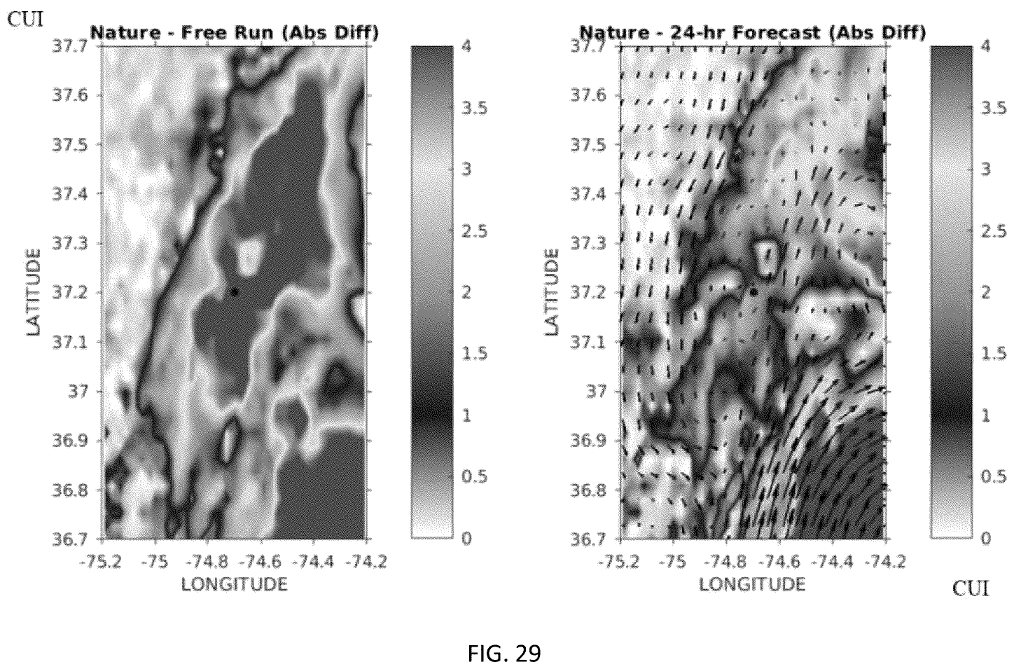

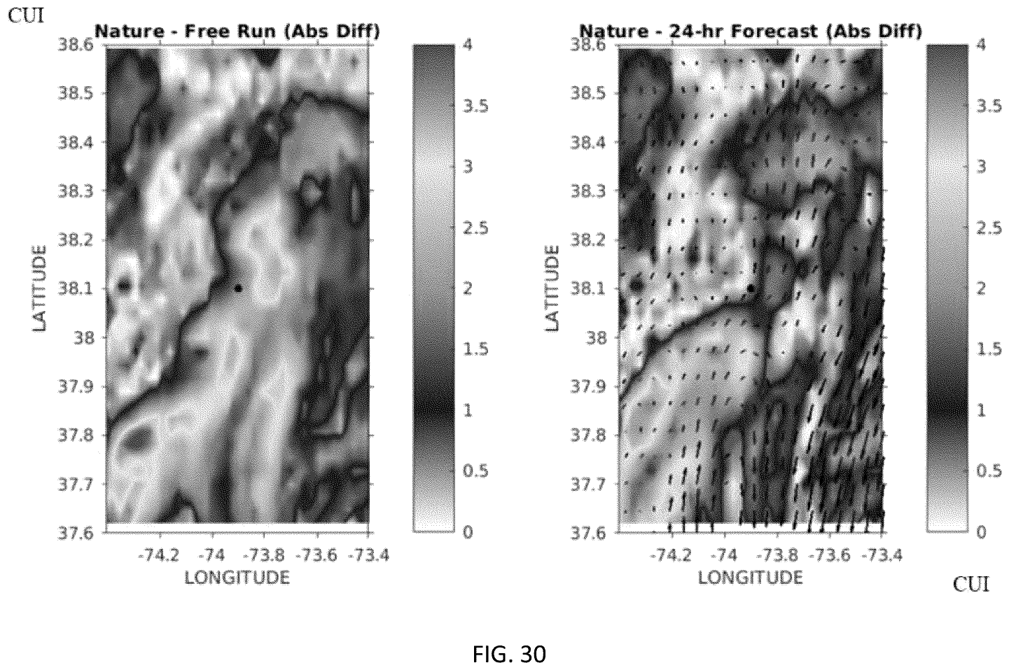

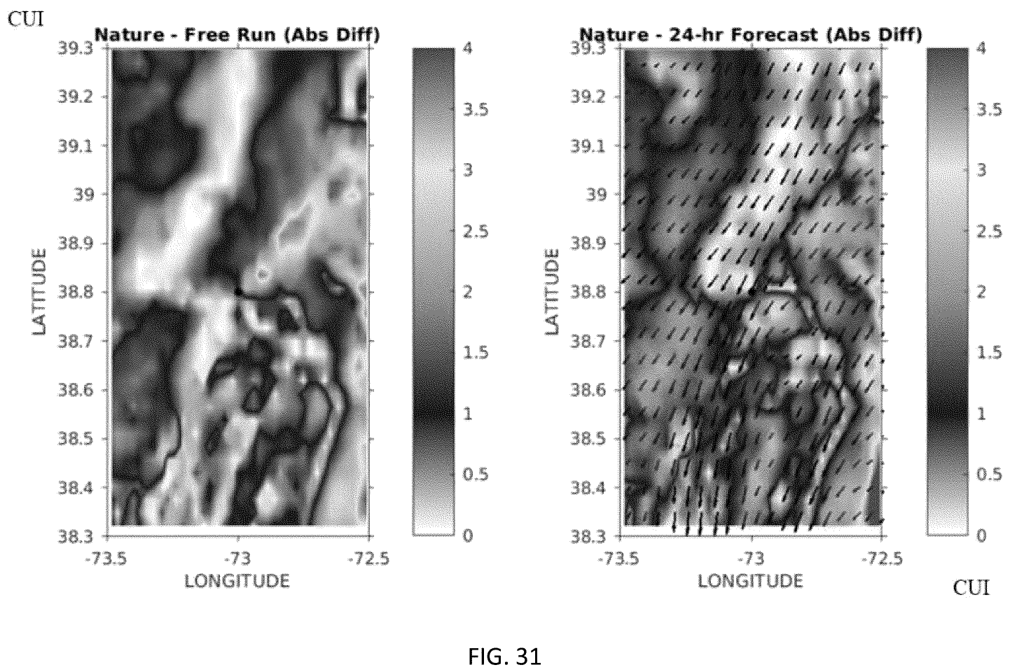

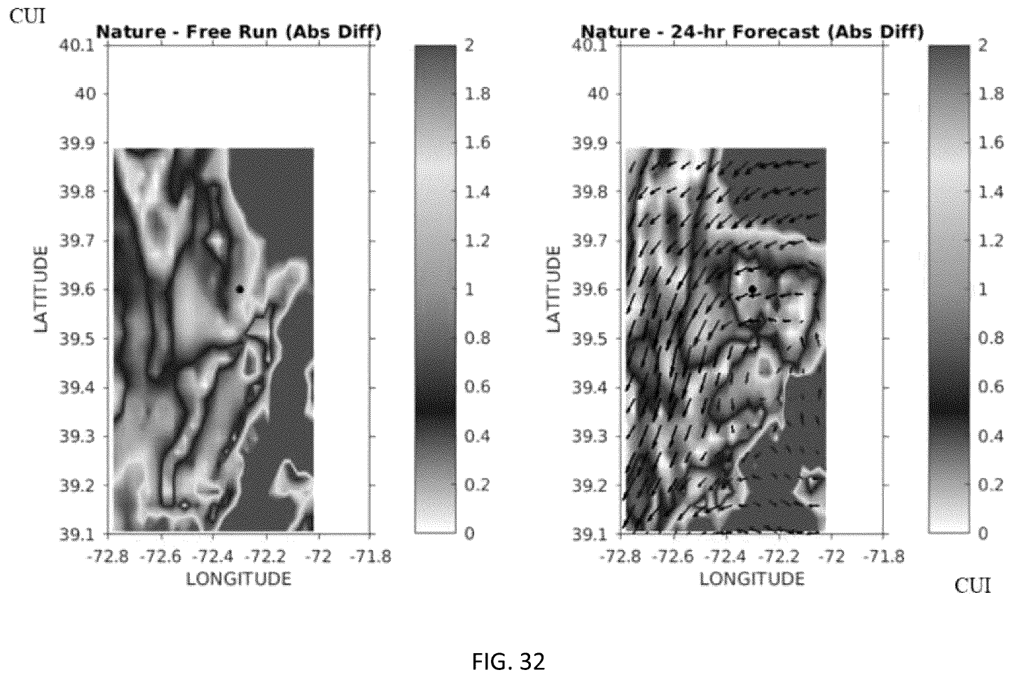

An analysis of the results centers on the impact of the acoustic observation assimilation in the region surrounding each source location. As shown in the sensitivity results and also the analysis increments shown in FIG. 28, it is expected that the influence radius of the acoustic observation assimilation will be greatest just around each source location (due to the flow dynamics of this particular domain). Therefore, the absolute difference between the NR and the 24-hr forecast within a 1° by 1° box surrounding each source location is computed. A representative date of 15 May, 2021 is selected for radials 0 and 1, while 25 May, 2021 is selected for radials 2 and 3; differences in temperature are shown due to the larger impact on that variable via data assimilation. FIGS. 29 and 30 show the absolute temperature difference between the NR and the FR (left panel) and 24-hr forecast (right panel) on 15 May, 2021 for radials 0 and 1, respectively, at a depth of 25 m. The currents from the 24-hr forecast are shown in the right-hand panel in order to provide guidance on the evolution of the analysis correction over time, as the perturbation brought to the forecast from the analysis increments will generally evolve in the direction of the flow. For FIG. 29 the impact of the assimilation is dramatic, as the error in the region surrounding the source location (shown by the black dot) is reduced from near 5° C. to generally less than 3° C., and this error reduction extends well north and south of the source location itself. This dual-direction correction is likely the result of the underlying currents in the 24-hr forecast, which exhibit a southward-moving flow to the west of the source location and a more northward-moving flow to the east. The error reduction at radial 1 is not quite as large, but is still substantial, with errors reduced from around 3 to 4° C. to around 1 to 2° C. in the area surrounding the source location (FIG. 30). Most of this correction extends to the north, in the direction of the predominant currents surrounding radial 1. FIG. 31 shows the absolute difference in temperature around radial 2 at 25 m depth on 25 May, 2021. Unlike what was shown in FIGS. 29 and 30, the correction around radial 2 is marginal at best. Though the correction at the source location itself is still positive, this improvement is not shown to spread away from that location. In fact, the error is slightly higher south of the radial in the direction of the strong southward-moving current. The stronger currents here may play a role in limiting the time-scale of the assimilation and may also help explain the generally mediocre performance of the assimilation at this radial over time (as shown in FIG. 24). FIG. 32 shows the temperature difference in the vicinity of radial 3 at 25 m depth on 25 May, 2021; as this radial is near the northeast corner of the domain, part of the 1° by 1° box extends beyond the model boundary. The result here is similar to what is shown for radials 0 and 1, as the correction brought via assimilation is significant, reducing error surrounding the radial from around 1.5 to 2 ° C. to below 0.5 ° C. The underlying current shows a cyclonic eddy centered near 39.4° N by −72.25° W with the source location for radial 3 embedded in the northern portion of the eddy. It is possible that this region exhibits a strong reduction in error, compared to the FR, due to this eddy where the currents act to move the analysis correction generally over the same area over time. In any case, the difference plots from FIGS. 29 through 32 indicate that the assimilation of acoustic pressure measurements not only positively impact the ocean model at the location of the source location, but also within the surrounding region as well.

### 4.0 A Comparison of the Assimilation of Acoustic Pressure Observations Using 3DVAR and 4DVAR Approaches

This section describes the use of variational methods based on the four dimensional variational (4DVAR) technique to assimilate acoustic pressure observations in an Observing System Simulation Experiment (OSSE) using the adjoint of the Range-dependent Acoustic Model (RAM) [9] and the Navy Coastal Ocean Model (NCOM) 4DVAR analysis system. The results showed good correction of the ocean environment in the vicinity of the acoustic source location and that correction was propagated from the analysis to the short-term forecast and persisted through all 31 days of the experiment. The 4DVAR method was chosen for that study due to the complexity of the four-dimensional background error covariance provided by 4DVAR, as it was expected this would provide the best use of the acoustic observations for ocean state analysis and forecasting. The 4DVAR method, however, is relatively computationally expensive and can be difficult to derive as it requires the careful construction of the tangent linear and adjoint of an entire ocean modeling system in order to be used. There are several competing analysis methods, such as the simpler three-dimensional variational (3DVAR) approach [35], as well as the various flavors of the Kalman filter, see [36], [37], [38], that are simpler to construct and are far more computationally efficient. The question is, can one of these simpler methods have similar success with the assimilation of acoustic observations as was demonstrated with the 4DVAR approach? This current study aims to assess the performance of the adjoint method for acoustic data assimilation, but with the simpler 3DVAR approach rather than 4DVAR. Here, the adjoint and tangent linear of RAM are used as observation operators within a 3DVAR ocean analysis system. The results are compared to the more complex 4DVAR approach in order to examine the performance relative to the more complex method.

Section 4 is organized as follows: a description of the models (both oceanographic and acoustic), the data assimilation methods used, and the OSSE configuration and observation sampling are described in section 4.1 while section 4.2 provides and discusses the results of the experiment.

### 4.1 The Models, Methods, and the OSSE Configuration and Observation Sampling

The ocean model used in this study is the Navy Coastal Ocean Model (NCOM) [10]. NCOM is a primitive equation model that uses the hydrostatic and Boussinesq approximations and employs the Mellor-Yamada Level 2.5 turbulence closure parameterization for vertical diffusion, and a third-order upwind advection scheme (that is naturally diffusive in the horizontal). The model can be setup to have a number of different vertical coordinate configurations; for this work, NCOM has free sigma levels (terrain following) over fixed z-levels. NCOM is a regional model and relies on a parent ocean model for lateral boundary conditions. For this study, the Navy's Global Ocean Forecast System (GOFS v3.1) provides lateral boundary forcing at 3-hour intervals, while the surface atmospheric forcing is provided by the Navy's Coupled Ocean/Atmosphere Prediction System (COAMPS©) at hourly intervals [20]. In addition to the ocean model, a parabolic equation model known as RAM is employed to model the ocean acoustic pressure. RAM, described in [9], is configured as a two-dimensional range/depth plane model that is initialized with an initial acoustic pressure profile and forced with ocean sound speed profiles at regular intervals along the range/depth plane to simulate the ocean acoustic pressure. In order to simulate the sound propagation from some source, RAM requires the source geographical location, depth, and frequency. RAM obtains the ocean sound speed profiles from an ocean model (NCOM in this study), and the sound speed is computed from the ocean model temperature and salinity using the Chen-Millero-Li method [16], [17]. Bilinear interpolation is used to map the model temperature and salinity profiles to the locations along the RAM range/depth plane, where the sound speed is then computed. The main data assimilation system used in this work is the NCOM-4DVAR analysis system [13], [14]. NCOM-4DVAR is based on the representer-method of 4DVAR [16], [17], and can be configured to run as a weak-constraint system that attempts to account for both the initial condition as well as the model error. As in any variational assimilation system, the NCOM-4DVAR is derived from the basic form of the variational cost function:

$$J ( x ) = \frac{1}{2} {( x - {x}_{b} )}^{T} {B}^{- 1} ( x - {x}_{b} ) + \frac{1}{2} {( y - {Hx}_{b} )}^{T} {R}^{- 1} ( y - {Hx}_{b} ) \qquad ( 11 )$$

where x_{b} is the model background state vector; y is the observation vector; H is the nonlinear observation operator (that maps the model state to the space of the observations); and B and R are the background and observation error covariances, respectively. After some derivation Eq. (11) can be used to derive what is known as the analysis equation:

δx^{a}=BH^{T}(HBH^{T}+R)⁻¹(y−Hx_{b}) (12)

where δxₐ is the analysis increment that is added to the model background state to form

the analysis, and H is the linearized observation operator (with H^{T} as the transpose or adjoint operator). In the case of the representer method for 4DVAR, B in Eq. (12) can be expanded to include the tangent linear and adjoint operators of the nonlinear ocean model [2] so that Eq. (12) becomes:

δxₐ=MΣCΣ^{T}M^{T}H^{T}(HMΣCΣ^{T}M^{T}H^{T}+R)⁻¹(y−Hx_{b}) (13)

where M is the tangent linear of the ocean model (and M^{T} is its adjoint), τ is the background error standard deviation, and C is the background error correlation matrix. In 4DVAR, the tangent linear and adjoint model are used in concert with one another to provide a number of features to the analysis, including the time variability of the correction (i.e. four-dimensional error covariance) and dynamical balance relationships based on the linearized dynamics of the nonlinear ocean model (cross-covariance terms).

Typically, the inversion in Eq. (13) is solved using a linear solution method such as one of the conjugate gradient approaches. This requires multiple applications of the tangent linear and adjoint model over a number of iterations until the conjugate gradient converges to a solution. Depending on the size of the problem (model domain size, horizontal and vertical resolution, and length of the assimilation window) the 4DVAR can be computationally expensive. Eq. (13) can be simplified by reducing the tangent linear and adjoint of the ocean model to identity matrices such that Eq. (13) becomes a 3DVAR method:

δxₐ=ΣCΣ^{T}M^{T}H^{T}(HΣCΣ^{T}H^{T}+R)⁻¹(y−Hx_{b}) (14)

The inverse in Eq. (14) is faster to solve as the covariance ΣCΣ^{T} can be applied in an efficient manner. In the case of the data assimilation algorithms used in this work, the correlation matrix, C, is provided by an operator based on the implicit solution to a diffusion equation [39],[40] and is computationally efficient. There is no account for the time variability of the observations on the solution in Eq. (14), however, as that is a necessary consequence of using a simpler method than 4DVAR. The dynamical balance relationships are also missing in Eq. (14), but they can be approximated by adding additional operators. Following the work of [41], a linearized “balance operator” can be constructed based on geostrophy and hydrostatics. Doing so would alter Eq. (14) so that the embedded background error covariance would have the additional operators:

δxₐ=K_{b}ΣCΣ^{T}K_{b}^{T}H^{T}(HK_{b}ΣCΣ^{T}K_{b}^{T}H^{T}+R)⁻¹(y−Hx_{b}) (15)

where K_{b} is the linear balance operator (and K_{b}^{T} its adjoint). Eq. (15) is the base form of the 3DVAR used in this work, with the software derived from the larger 4DVAR system. Both the 3DVAR and 4DVAR used in this study employ a conjugate gradient solver with a preconditioner based on the work of and explored with the NCOM-4DVAR in [43]. In order to assimilate acoustic pressure observations with the ocean 3DVAR or 4DVAR systems, a suitable linear observation operator must be provided that maps the ocean variables to the space of the acoustic pressure observations (and vice versa). RAM depends nonlinearly on the sound speed [3] and, therefore, a tangent linear operator must be derived. The details of this derivation can be found in [3], as well as the construction of the linear transpose, or adjoint, model of RAM. These operators are known collectively as Variational RAM (VRAM). These VRAM operators are linked to the 3DVAR and 4DVAR algorithms as the embedded H and H^{T} operators in Eqs. (13) and (15).

For the study shown here, the 4DVAR is run in weak constraint mode, with model errors set as 10% of the initial condition error (with an identical spatial distribution); the initial condition errors are generated by the Navy Coupled Ocean Data Assimilation (NCODA) system using the Generalized Digital Environmental Model (GDEM4) climatological database from [34]. The 4DVAR is run with a 48-hr assimilation window and observations are assimilated every 6 hours. For the 3DVAR (e.g., in some embodiments), only the initial condition error is used (identical to that used in 4DVAR) and observations are only assimilated once at the analysis time. The cycling runs shown here conduct an analysis every 24-hrs and a 24-hr forecast is run from each analysis from 1 through 31 May, 2021.

These models are applied using an OSSE methodology. An OSSE is a powerful tool that can be used to examine either a new data assimilation system, observation type or platform, or both [44], [25]. Typically, an OSSE experiment will consist of two component models, a proxy for the “real” ocean (known as the nature run) and a model that will assimilate observations (known as the assimilative run). The nature run must be of sufficiently high spatial resolution so as to resolve smaller-scale features and phenomenon that exist in the real ocean and that are not always captured by lower-resolution operational ocean models. The assimilative run, on the other hand, should suffer from sources of error that are typical for an ocean model (and a regional model in the case of this study). These sources of error include initial condition error (due imperfect analysis of the starting ocean state), imperfect boundary conditions, and errors due to resolution (i.e. unresolved features). These errors can be included, for example, by providing the assimilative model a different initial condition than is used by the nature run, time-shifting the boundary conditions, and running the assimilative model at lower resolution than the nature run. One can also use entirely different ocean models for the nature and assimilative model runs to truly uncouple the runs from one another.

In this study, the nature and assimilative runs are both conducted using NCOM, known as a fraternal twin experiment. Here both models cover the same geographical area, with the domain extending from 71.4° to 76.7° W longitude and 35.7° to 40.0° N latitude. The nature run is configured for 100 vertical levels with a horizontal resolution of 1 km. The assimilative model, on the other hand, has only 50 vertical levels with a horizontal resolution of 3 km. The nature run is initialized on 1 Mar. 2021 and is run through 31 May, 2021. The months of March and April are used as a spin-up period leaving the month of May for the study period shown in this work. The assimilative model is initialized on 1 Apr. 2021, but using an initial condition derived from GOFS on 15 Apr. 2021. This time-shift provides additional error to the initial condition and produces a model solution in the assimilative run that differs substantially from the nature run. No additional source of error is included in the assimilative model as the initial condition time shift and resolution differences produce a model solution during the month of May that is of sufficient difference.

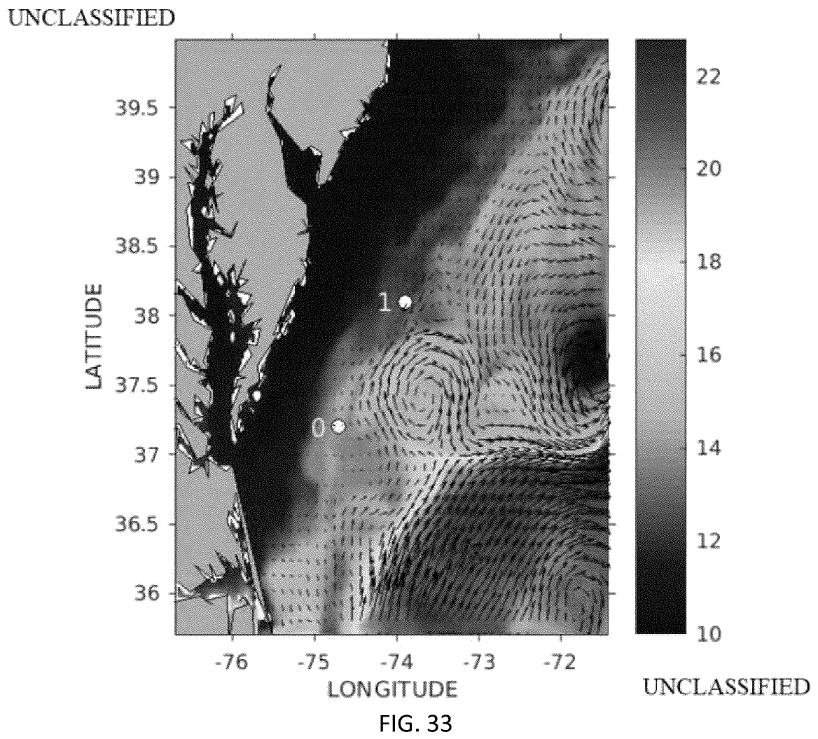

The focus of this study is to compare and contrast the assimilation of simulated acoustic pressure observations using a 3DVAR and 4DVAR assimilation method; as such, acoustic pressure observations must be sampled from the nature run in this OSSE. To do this, RAM is run along specific range/depth planes positioned within the ocean domain, and the ocean nature run provides environmental profiles of temperature and salinity to be used to compute the sound speed as required by RAM. For this work two such range/depth planes are configured to provide acoustic pressure “observations” for assimilation. Each plane is roughly 2000 m in length from source to the location of the simulated receivers. Due to the resolution of the assimilative model, this short distance effectively makes the RAM model range-independent as only one model profile is used to provide sound speed for the entire plane (e.g., in some embodiments). At the end of each plane the simulated acoustic pressure from the nature run is sampled at depths from 15 m to 105 m, every 15 m; this simulates the sampling one might get from a typical vertical line array. The location of each acoustic source is fixed in time (no moving targets) and is shown in FIG. 33 by the white dots (FIG. 33 also shows the SST of the assimilative model on 1 May, 2021 with the ocean current vectors also shown). The source locations are labeled 0 and 1 and will be referred to as “radial 0” and “radial 1” throughout the text (as RAM typically runs a series of range/depth planes as radials around a source location). It is noted that the only difference (e.g., in some embodiments) between the RAM run that generates the observations and the RAM run used in the assimilative model is the environmental profile input. RAM also relies on geoacoustic conditions as well as surface wind/wave states. For this work, those conditions are identical between the nature and assimilative model runs. This is certainly idealized; however, this configuration will help to isolate the impact of the ocean state alone on the acoustic propagation. Observations are generated at a frequency at 50 Hz, a low frequency domain following the work of [21], with a source depth of 50 m.

### 4.2 Assimilation Experiment Results and Discussion

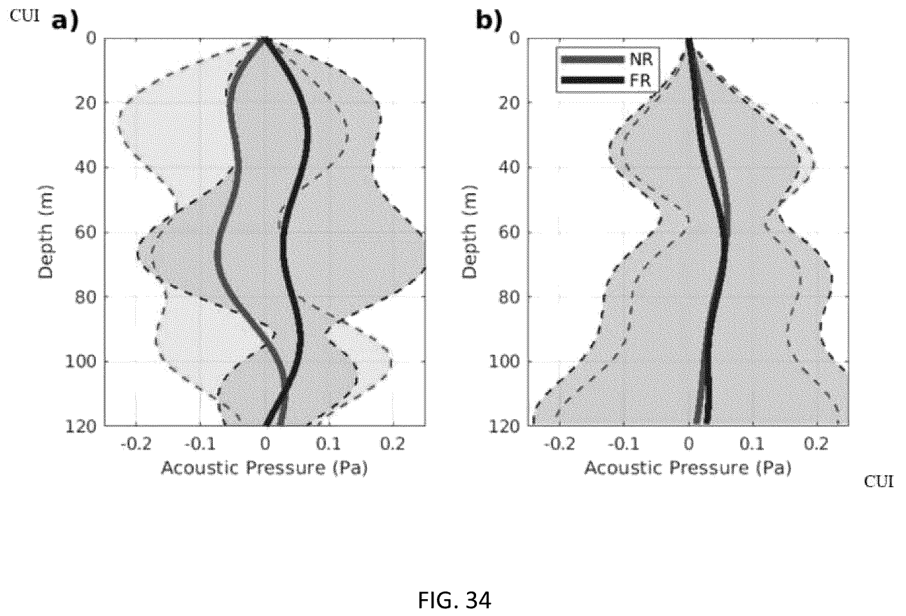

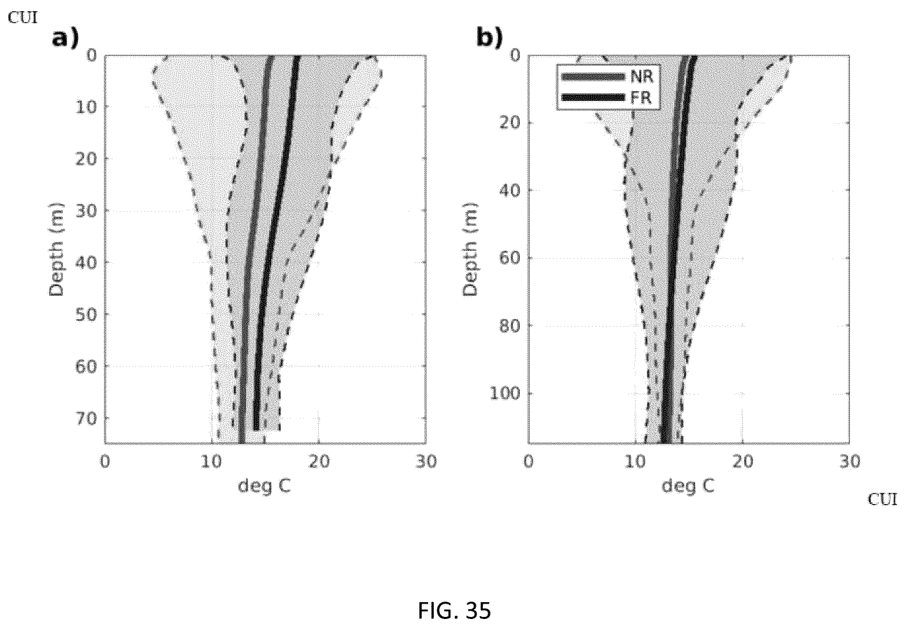

Prior to examining the results of the assimilation experiments it is useful to investigate the performance of the free-run model against the nature run in order to gauge the impact of the observations on the model's performance. In this case, we can examine the performance in two ways, the acoustic model performance and the ocean model performance. For the acoustic model, let us examine the acoustic pressure simulation from the free-run model versus that from the nature run at the end of radial 0 and radial 1. FIG. 34 shows this comparison with the mean acoustic pressure profile (real component only, in Pascals), computed at 0 z daily from 1-31 May, 2021, from the nature run (NR) shown in red and the free run (FR) shown in blue; the standard deviation over this time frame is shown in the shaded regions (light red for the NR and light blue for the FR). FIG. 34a shows the values from radial 0 and FIG. 34b from radial 1. The difference between the NR and the FR at radial 0 is relatively large, nearly 0.1 Pa at certain depths. In addition to this, the deviation from the mean state is large for the FR near 70 m depth, but largest for the NR nearer to 20 m depth. For radial 1, the difference between the NR and FR is much smaller than seen at radial 0, with peak differences around 40 m and 120 m depth. Also, the overall deviation from the mean is larger, at almost all depths, for the FR than for the NR. As for the oceanographic comparison between the FR and NR, FIG. 35 shows the mean temperature and standard deviation from 1-31 May, 2021 at the location of the source for radial 0 (FIG. 35a) and radial 1 (FIG. 35b); the mean temperature profile is shown in red for the NR and blue for the FR, and the shaded red (blue) region is the standard deviation of the NR (FR). For the temperature profile at the source location of radial 0, the FR temperature shows a consistent warm bias over several degrees with much lower deviation from the mean over the course of May, 2021 (the deviation from the mean for the NR is rather large, especially nearer to the surface). For the source location of radial 1, however, the mean temperature is similar between the NR and the FR, however the deviation from the mean state is markedly different. The NR has a large deviation above 40 m depth and very narrow below, whereas the FR is narrower near the surface but broader from 40 m towards the bottom of the profile.

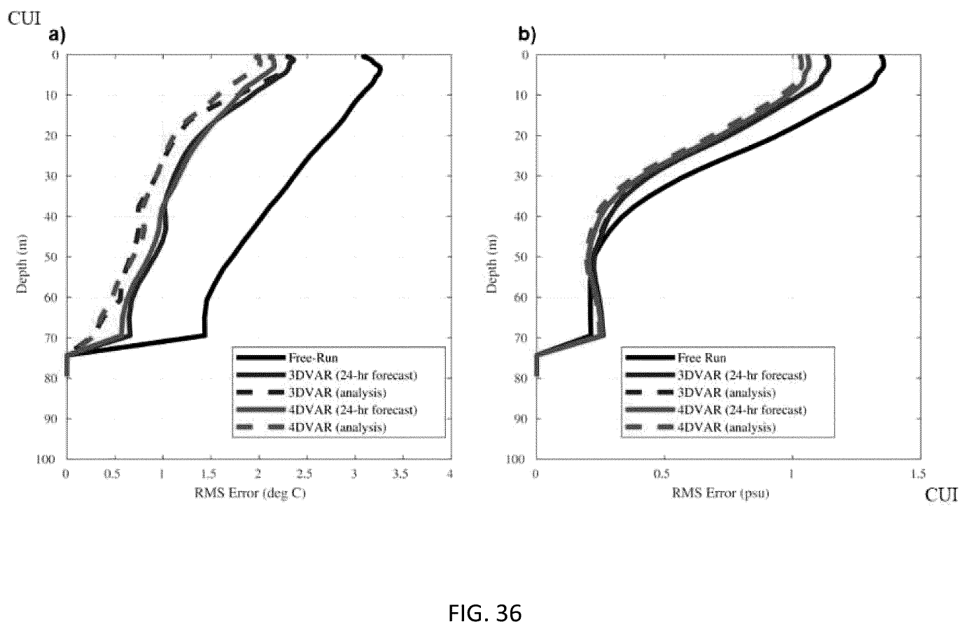

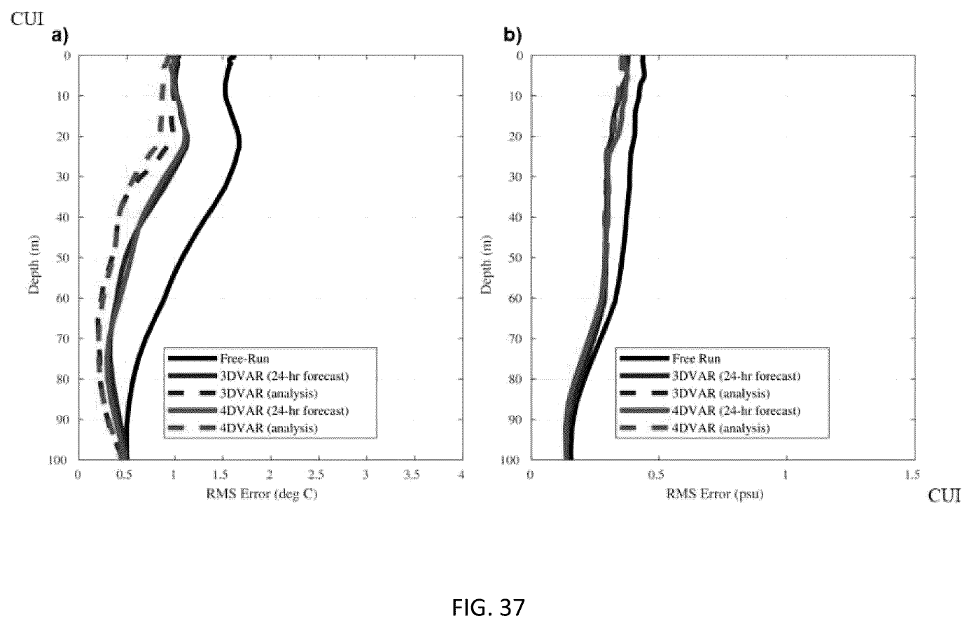

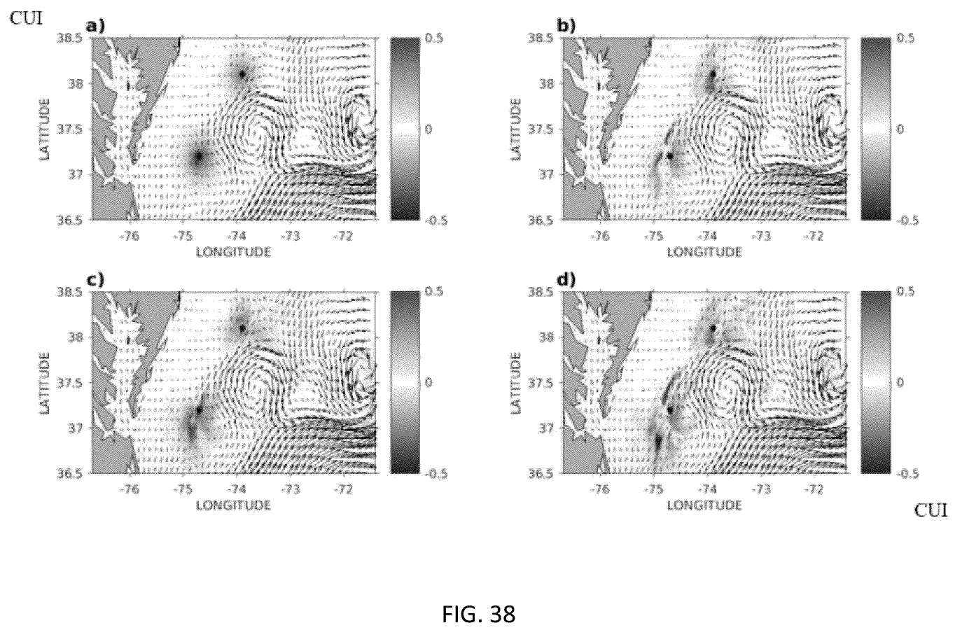

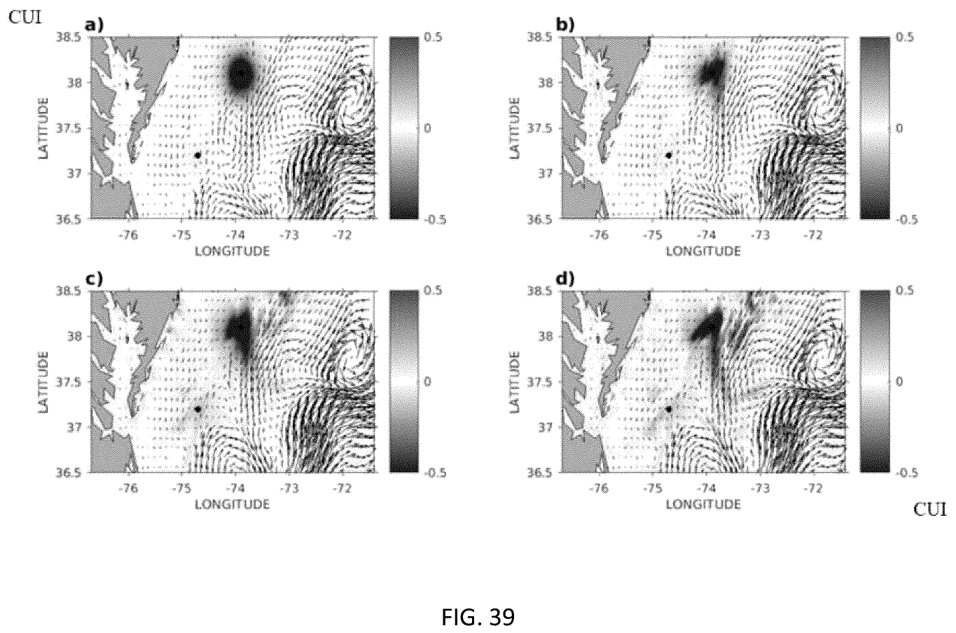

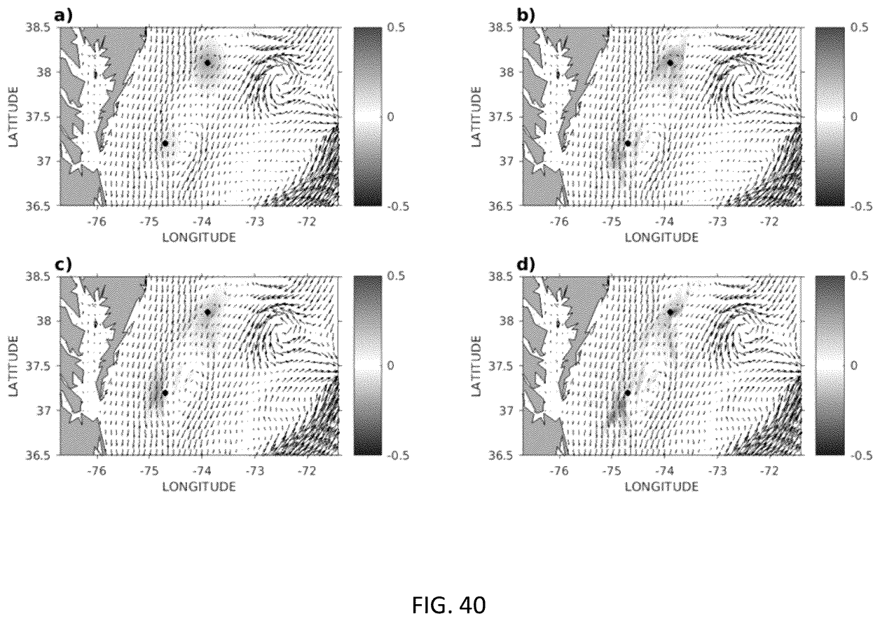

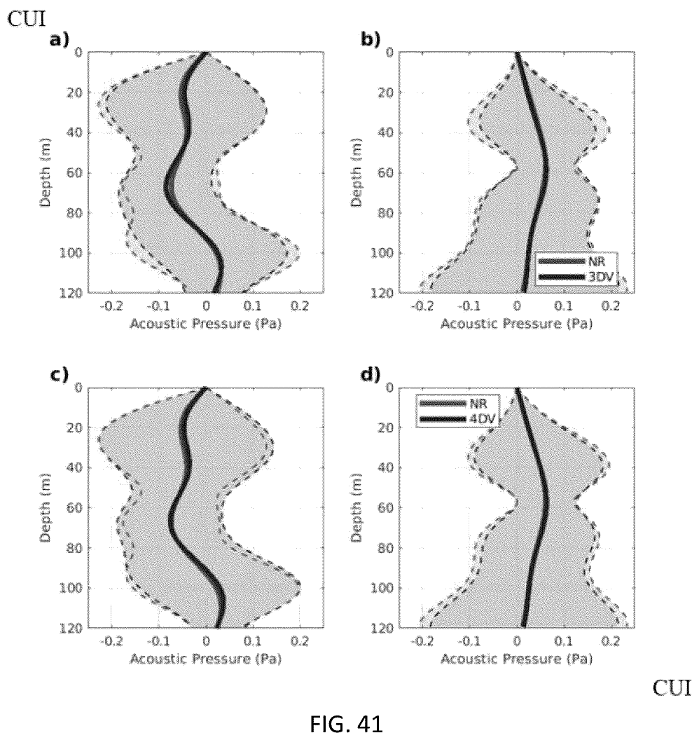

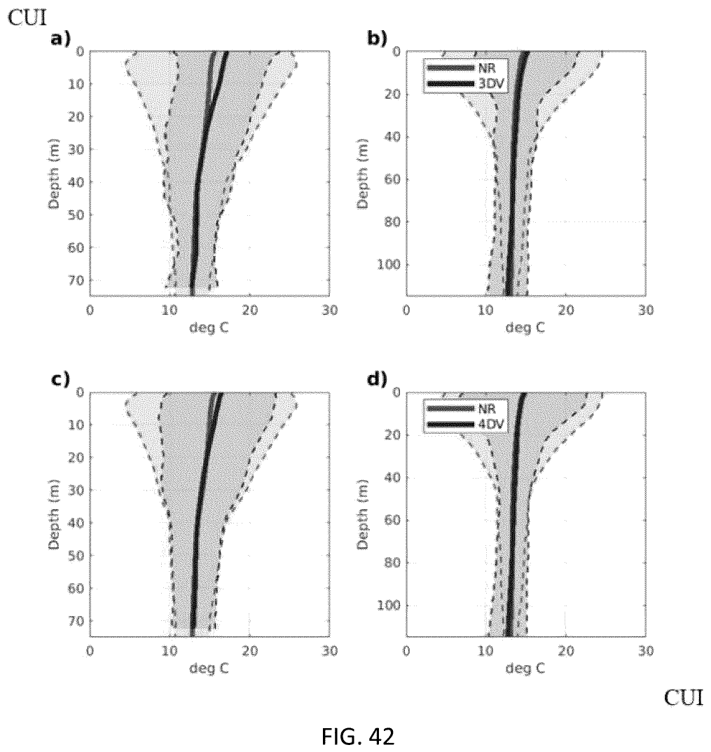

We can now examine both the analysis and 24-hr forecast error, from both the 3DVAR and 4DVAR experiments, by comparing the root mean square error (RMSE) of the source temperature and salinity profiles against the corresponding profiles from the NR. FIG. 36 shows the RMSE error of the temperature (FIG. 36a) and salinity (FIG. 36b) profiles at the source location for radial 0 from the FR (black line), 3DVAR experiment (blue line), and the 4DVAR experiment (red line); the error of each analysis is shown by the dashed lines, and the 24-hr forecast error as solid lines. Both the 3DVAR and 4DVAR experiments exhibit substantial improvement over that from the FR, with temperature errors dropping by about 1° C. at all levels and about 0.25 psu for salinity (near the surface). The RMSE for the 3DVAR and 4DVAR, both in the analysis and forecast, is roughly identical, save for near the surface where the 4DVAR experiment has slightly lower error. This result shows that the 3DVAR method is successfully assimilating the acoustic pressure observations in the analysis and this correction is maintained through the forecast step. FIG. 37 shows the same comparison as FIG. 36, but for the source profile location for radial 1. The overall error at this location is lower than in FIG. 36 (maximum FR temperature error near 1.6° C.), but the overall result is largely the same. Both the 3DVAR and 4DVAR experiment have much lower error in temperature (slightly lower in salinity). In some cases, there may be no clear advantage between either the 3DVAR or 4DVAR experiment for either quantity (temperature or salinity), again showing the excellent performance of the 3DVAR method relative to 4DVAR. To understand these results further, let us examine the nature of the analysis correction in the vicinity of each source profile. One of the primary reasons for using a 4DVAR approach to data assimilation over that of 3DVAR is the dynamical nature of the correction that is derived. Typically, 3DVAR methods produce relatively isotropic and homogeneous corrections to the model state due to the nature of the static background error covariance. Certainly, this can be relaxed if the 3DVAR method uses a more complex background error covariance, for example one derived from an ensemble of forecast states. 4DVAR, on the other hand, naturally provides a dynamic flow-dependent correction due to the action of the tangent linear and adjoint models as part of its 4D background error covariance. The 3DVAR used in this study, however, is designed to produce an isotropic and homogeneous correction. It is possible, however, that the correction derived by 3DVAR is altered over the 24-hr forecast period to be more anisotropic and inhomogeneous and its influence spread further in space. Such an alteration may explain why the correction derived in 3DVAR is maintained in the forecast step just as well as that seen in 4DVAR. To examine the evolution of the analysis increment perturbation during the forecast step, two separate forecast runs are made from the initial condition on 1 May, 15 May, and 31 May, 2021. One run uses the analysis increment as derived by either the 3DVAR or 4DVAR, the other run does not use the increment. Then, the forecast trajectory is differenced at the 24-hr time period in order to isolate the evolution of the analysis increment through the forecast step. FIGS. 38, 39, and 40, shows this for the analysis and forecast from 1 May (FIG. 38), 15 May (FIGS. 39), and 31 May (FIG. 40), with the forecast currents on 0 z and 24 z shown as arrow vectors on each plot. Each plot shows the 3DVAR increment at 25 m depth (FIGS. 38, a; 39, a; and 40, a), the 4DVAR increment at 25 m depth (FIGS. 38, c; 39, c; and 40, c), and the increment evolution at the end of the 24-hr forecast from 3DVAR (FIGS. 38, b; 39, b; and 40, b), as well as that from 4DVAR (FIGS. 38, d; 39, d; and 40, d). For each time period, the correction derived from 3DVAR is generally circular and uniform, showing no flow-dependence of any kind. The analysis increment from 4DVAR, on the other hand, shows strong flow dependence and analysis increments that can range far from the observation locations. The 4DVAR correction can, at times, show more structure than that from 3DVAR (especially on 15 May with a positive/negative structure near the northern portion of the domain). The evolution of the analysis increment from each analysis, however, at the end of the 24-hr forecast is remarkably similar. The analysis perturbation patterns from both 3DVAR and 4DVAR show strong flow-dependence at the end of the 24-hr forecast time period on each day shown, with 4DVAR showing some slightly more remote adjustments away from the observation locations relative to 3DVAR. It is surmised that it is this feature of the forecast step that is allowing the correction from 3DVAR to perform nearly as well as that from 4DVAR during the cycling analysis/forecast run through all 31 days of the experiment. We can examine the 3DVAR and 4DVAR experiment results in the same manner as the comparison of the FR to the NR shown in FIGS. 34 and 35. FIG. 41 shows the mean and standard deviation of the acoustic pressure profile (from 1-31 May, real component only) at the end of each radial for the forecast from the 3DVAR experiment for radial 0 (FIG. 41a) and radial 1 (FIG. 41b); and for the 4DVAR experiment for radial 0 (FIG. 41c) and radial 1 (FIG. 41d). Comparing these results to FIG. 34, both the 3DVAR and 4DVAR experiment substantially reduce the error in the acoustic pressure profile over than seen in the FR. Further, the deviation from the mean state is also largely corrected in both the 3DVAR and 4DVAR experiments. The result from the 4DVAR experiment shows a slightly closer match between the mean acoustic pressure profile from the NR, especially for radial 0 between 60-80 m depth. The deviation from the mean state is also slightly better for the 4DVAR result than the 3DVAR experiment. Even with this slight performance improvement in 4DVAR, the overall 3DVAR result is still excellent, especially given the improved computational efficiency given by the 3DVAR method (roughly 5× faster in terms of CPU wall-clock time within this study). FIG. 42 shows the same analysis as FIG. 35 (mean and standard deviation of the temperature profile at the source location, over 1-31 May, 2021) for 3DVAR at radial 0 (FIG. 42a) and radial 1 (FIG. 42b), and for 4DVAR at radial 0 (FIG. 42c) and radial 1 (FIG. 42d).

Again, when compared to FIG. 35, the 3DVAR and 4DVAR experiments show substantial improvements relative to the NR over that from the FR. Again, the mean temperature profile from 4DVAR matches the NR slightly better than that from 3DVAR, particularly for radial 0 nearer the surface. And, like the standard deviation in the acoustic pressure profile, the deviation from the mean for 4DVAR matches the NR better than from 3DVAR. Even still, the results from the 3DVAR experiment are nearly as good as those from the 4DVAR experiment.

### 5. Considerations

Section 2 of this report details the configuration of the coupled ocean-acoustic data assimilation software and an application of an adjoint sensitivity study is presented. The study shown here mainly focuses on short-range cases (2000 m), however results from a mid-range and a long-range case are also shown. This study shows that acoustic pressure at the end of each radial is sensitive to ocean temperature and salinity in a spatially-broad manner at 50 Hz for the short-range cases, but exhibits a more small-spatial-scale sensitivity to temperature and salinity at 300 Hz. This suggests that, given a data assimilation application, a more large-scale correction could be made using lower frequency acoustic pressure observations, while smaller-scale adjustments to the ocean profiles can be made using higher frequency acoustic pressure observations. The sensitivities exhibit a great deal of overlap, however, which precludes the possibility of simultaneous assimilation. This is akin to a multiscale problem, where observations contain both large and small scale information. In this case, a multiscale data assimilation approach has shown promise in previous works (Li et al., 2015; Carrier et al., 2019; Souopgui et al., 2020) and the general principle may be applied to the multifrequency data assimilation problem, where lower frequency observations are assimilated in the first analysis step while higher frequency observations are assimilated in a subsequent analysis step.

The sensitivity of acoustic pressure to the full four-dimensional ocean model state is also examined here. For this the coupled adjoint model is integrated for 120 hours and the sensitivity of acoustic pressure at the end of each radial is examined at two depths (0 and 50 m) across the entire ocean model domain. These results show significant displacement of the high sensitivity areas away from the radial locations themselves upstream the flow within the domain. This suggest that the acoustic pressure observations could have a substantial impact on the ocean model (spatially) given a sufficiently long assimilation window. Also, this indicates that coupled ocean-acoustic adjoint sensitivity information may be useful within an adaptive sampling application; this could be examined using an Observing System Simulation Experiment (OSSE; Zeng et al., 2020) study. A mid-range and long-range case is examined to investigate the possible impact of acoustic observations over longer ranges past 2 km. These results indicate that the impact to the ocean model from possible acoustic observation assimilation will be highly range and depth dependent based on the waveguide.

Section 3 provides a description of a simulated-observation assimilation case where the impact of the assimilation of acoustic pressure observations on the ocean model analysis and forecast is examined. A Mid-Atlantic Bight NCOM domain is used to assess the impact of acoustic pressure observations on the ocean model analysis and 24-hr forecast using a coupled ocean-acoustic 4DVAR system. This investigation uses an OSSE framework with simulated observations. In this case a high-resolution ocean model is used as the nature run and is used to provide the environmental profiles for a nature run of the acoustic model, RAM, from which simulated acoustic pressure observations are sampled. Four source locations (with a source depth of 50 m at a frequency of 50 Hz) are used with one short-range radial extending from each source by roughly 2 km. The nature run and the assimilative model both treat each radial as range-independent, due to the short nature of each radial relative to each model's horizontal resolution. The simulated acoustic pressure observations are assimilated daily over a 31-day period covering May, 2021. The results of the assimilative model's analysis and 24-hr forecast are compared directly to the nature run at the location of each environmental profile as well as within a 1° by 1° box surrounding each profile. The results of this comparison show that the acoustic pressure observations have a generally positive impact on the assimilative model analysis and 24-hr forecast, with substantially lowered errors at the location of the environmental profile itself, and a decrease of error within the region surrounding each profile relative to the FR. The results shown here indicate that acoustic pressure observations can have a positive impact on ocean state estimation, as well as for improving short-term ocean forecasts.

Section 4 of this report details the relative performance of a 3DVAR approach to the assimilation of acoustic pressure observations relative to the more complex 4DVAR approach as well as a non-assimilative free run model within an OSSE configuration. The results show that the 3DVAR method can properly assimilate acoustic pressure observations, with errors nearly identical to that from a 4DVAR method, when employing the same observation operators derived from an acoustic model (RAM). The 4DVAR method does show some slight improvement in performance in terms of correction to the temperature profile at the source location nearer the surface, as well as capturing the character of the standard deviation from the mean profile over all 31 days of the experiment. The 4DVAR method also shows some slight improvement over the 3DVAR in terms of the acoustic pressure profile at the end of each radial, especially radial 0 from 60-80 m depth. Despite this slightly improved performance from 4DVAR, the results from the 3DVAR experiment are still very competitive and nearly identical in some cases with the 4DVAR. And given the superior computational efficiency of the 3DVAR method (roughly 5× faster in this study), the selection of the 3DVAR method for acoustic observation assimilation certainly produces meaningful and useful results.

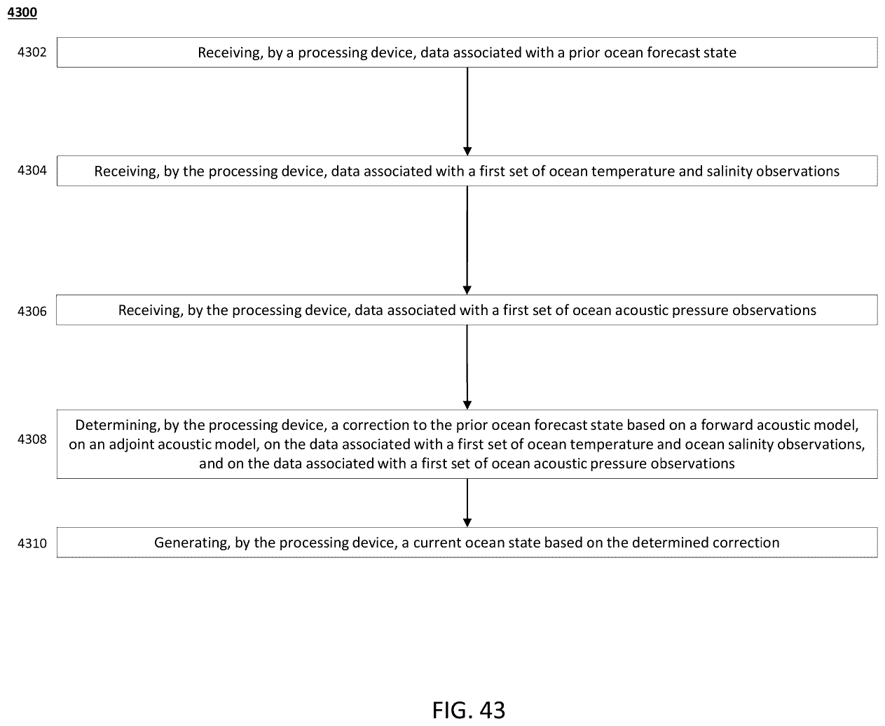

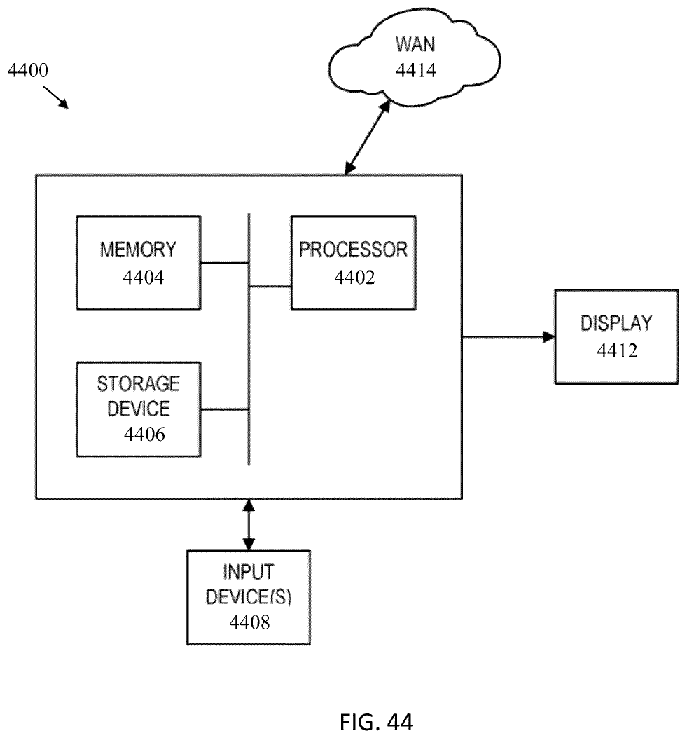

FIG. 43 illustrates an example method 4300, in accordance with one or more disclosed aspects. For example, method 4300 may be a method of determining ocean state and may include one or more steps. Step 4302 may include receiving, by a processing device (e.g., such as computer system 4400, shown in FIG. 44), data associated with a prior ocean forecast state. Step 4304 may include receiving, by the processing device, data associated with a first set of ocean temperature and salinity observations. Step 4306 may include receiving, by the processing device, data associated with a first set of ocean acoustic pressure observations. Step 4308 may include determining, by the processing device, a correction to the prior ocean forecast state based on a forward acoustic model, on an adjoint acoustic model, on the data associated with a first set of ocean temperature and ocean salinity observations, and on the data associated with a first set of ocean acoustic pressure observations. Step 4310 may include generating, by the processing device, a current ocean state based on the determined correction. One or more steps may be repeated, added, modified, and/or excluded, such as in accordance with aspects described herein.

According to some aspects, one or more disclosed embodiments may have one or more specific applications. According to some aspects, one or more disclosed aspects may be used to facilitate a water-based operation. For example, ocean forecasts, such as described herein, can be used for drift prediction, search & rescue, and acoustic modeling. According to some aspects, one or more disclosed aspects may be used to develop a mission route plan associated with operating a vessel. In some cases, one or more disclosed aspects may be used to facilitate a strategic operation, which can include a defensive tactical operation or naval operation. One or more aspects described herein may be used to facilitate naval operations.

In one example, Navy Tactical Decision Aids rely heavily on ocean model output for accuracy. Ocean models rely on observations to maintain accuracy, but the ocean is severely under-observed. Navy Tactical Decision Aids rely on accurate ocean model forecasting, and use of ocean acoustic observations as described herein are a source of observation that improves the ocean model accuracy. This may provide personnel (e.g., Navy personnel, etc.) the capability to use an existing observation that is abundant and already collected, but in a new and novel way as described herein.

In some cases one or more aspects may involve the method of data assimilation itself. In this case, acoustic pressure observations could be employed within a method of Kalman Filtering (KF). In this approach, the same observation operators could be used within any flavor of the Kalman approach, where an ensemble of ocean model forecasts provides the ocean background error covariance. The anticipated result would be similar to any comparison of 3DVAR/4DVAR/KF.

According to some aspects, one or more aspects described herein may be applied in a series of simulated-observation studies to greatly reduce ocean model error in both the analysis and 24-hour forecast.

One or more aspects described herein may be implemented on virtually any type of computer regardless of the platform being used. For example, as shown in FIG. 44, a computer system 4400 includes a processor 4402, associated memory 4404, a storage device 1006, and numerous other elements and functionalities typical of today's computers (not shown). The computer 4400 may also include input means 4408, such as a keyboard and a mouse, and output means 4412, such as a display, monitor, and/or LED. The computer system 4400 may be connected to a local may be a network (LAN) or a wide may be a network (e.g., the Internet) 4414 via a network interface connection (not shown). Those skilled in the art will appreciate that these input and output means may take other forms.

Further, those skilled in the art will appreciate that one or more elements of the aforementioned computer system 4400 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein. According to some aspects, one or more steps of method 4300 may be performed by the computer system 4400 and/or one or more components of computer system 4400. In some cases, one or more aspects may include causing display of a generated current ocean state forecast, such as via output means 4412.

Embodiments for the use of ocean acoustic pressure observations for ocean model analysis and forecasting been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### REFERENCES

1. Roemmich, D., and Coauthors, 2001: Argo: The global array of profiling floats. Observing the Oceans in the 21st Century, C. J. Koblinsky and N. R. Smith, Eds., Melbourne Bureau of Meteorology, 248-257.
2. Li, Y., I. M. Navon, P. Courtier, and P. Gauthier, 1993: Variational data assimilation with a semi-Lagrangian semi-implicit global shallow-water equation model and its adjoint. Mon. Wea. Rev., 121, 1759-1769. https://doi.org/10.1175/1520-0493(1993)121%3C1759:VDAWAS%3E2.0.CO;2
3. Ngodock, H. E., M. J. Carrier, J. Fabre, R. Zingarelli, and I. Souopgui, 2017: A variational data assimilation system for the range dependent acoustic model using the representer method: Theoretical derivations. J. Acoust. Soc. Am., 142(1), 186-194. http://dx.doi.org/10.1121/1.4989541.
4. Hermand, J. P., M. Berrada, M. Meyer, and M. Asch, 2006: Adjoint-based geoacoustic inversion with an uncertain sound speed profile. In Proceedings of the Eighth European Conference on Underwater Acoustics, edited by S. M. Jesus and O. C. Rodriquez, Carvoeiro, Portugal.
5. Le Gac, J.-C., Y. Stephan, M. Asch, P. Helluy, and J.-P. Hermand, 2004: A variational approach for geoacoustic inversion using adjoint modeling of a PE approximation model with nonlocal impedance boundary conditions. In Theoretical and Computational Acoustics 2003, edited by A. Tolstoy, Y. Teng, and E. Shang (World Scientific Publishing, Singapore), pp. 254-263.
6. Thode, A., and K. Kim, 2004: Multiple-order derivatives of a waveguide acoustic field with respect to sound speed, density, and frequency. J. Acoust. Soc. Am., 116(6), 3370-3383.
7. Meyer, M., and J.-P. Hermand, 2005: Optimal nonlocal boundary control of the wideangle parabolic equation for inversion of a waveguide acoustic field. J. Acoust. Soc. Am., 117(5), 2937-2948.
8. Li, J. L., L. L. Jin, and W. Xu, 2014: Inversion of internal wave-perturbed sound-speed field via acoustic data assimilation. IEEE J. Ocean. Eng., 39(3), 407-418.
9. Collins, M. D., R. J. Cederberg, D. B. King, and S. A. Chin-Bing, 1996: Comparison of algorithms for solving parabolic wave equations. J. Acoust. Soc. Am., 100(1), 178-182.
10. Barron, C. N., A. Birol Kara, P. J. Martin, R. C. Rhodes, and L. Smedstad, 2006: Formulation, implementation and examination of vertical coordinate choices in the Global Navy Coastal Ocean Model (NCOM). Ocean Modell., 11, 347-375.
11. Chen, C.-T., and F. J. Millero, 1977: Sound speed in seawater at high pressures. J. Acoust. Soc. Am., 62, 1129-1135.
12. Millero, F. J., and X. Li, 1994: Comments on ‘On equations for the speed of sound in seawater’ [J. Acoust. Soc. Am., 93, 255-275 (1993)], J. Acoust. Soc. Am., 95(5), 2757-2759.
13. Ngodock, H. E., and M. J. Carrier, 2014a: A 4DVAR system for the Navy Coastal Ocean Model. Part I: System description and assimilation of synthetic observations in Monterey Bay. Mon. Wea. Rev., 142, 2085-2107. https://doi.org/10.1175/MWR-D-13-00221.1.
14. Ngodock, H. E., and M. J. Carrier, 2014b: A 4DVAR system for the Navy Coastal Ocean Model. Part II: Strong and weak constraint assimilation experiments with real observations in Monterey Bay. Mon. Wea. Rev., 142, 2108-2117. https://doi.org/10.1175/MWR-D-13-00220.1.
15. Bennett, A. F., 1992: Inverse Methods in Physical Oceanography. Cambridge University Press, New York, 347 pp.
16. Bennett, A. F., 2002: Inverse Modeling of the Ocean and Atmosphere. Cambridge University Press, New York, 234 pp.
17. Chua, B. S., A. F. Bennett, 2001: An inverse ocean modeling system. Ocean Modell., 3, 137-165.
18. Courtier, P., 1997: Dual formulation of four-dimensional variational assimilation. Quart. J. Roy. Meteor. Soc., 123, 2449-2461.
19. Mellor, G. L., and T. Yamada, 1982: Development of a turbulence closure model for geophysical fluid problems. Rev. Geophys. Space Phys., 20, 851-875.
20. Hodur, R. M., 1997: The Naval Research Laboratory's Coupled Ocean/Atmosphere Mesoscale Prediction System (COAMPS). Mon. Wea. Rev., 125, 1414-1430, https://doi.org/10.1175/1520-0493(1997)125<1414:TNRLSC>2.0.CO;2
21. Storto, A., S. Falchetti, P. Oddo, Y.-M. Jiang, and A. Tesei, 2020: Assessing the impact of different ocean analysis schemes on oceanic and underwater acoustic predictions. J. Geophys. Res. Oceans, 125, e2019JC015636, https://doi.org/10.1029/2019JC015636.
22. Li, Z., J. C. McWilliams, K. Ide, and J. D. Farrar, 2015: Coastal ocean data assimilation using a multi-scale three-dimensional variational scheme. Ocean Dyn., 65, 1001-1015, https://doi.org/10.1007/s10236-015-0850-x
23. Carrier, M. J., J. J. Osborne, H. E. Ngodock, S. R. Smith, I. Souopgui, and J. M. D'Addezio, 2019: A multiscale approach to high-resolution ocean profile observations within a 4DVAR analysis system. Mon. Wea. Rev., 147, 627-643, https://doi.org/10.1175/MWR-D-17-0300.1.
24. Souopgui, I., J. M. D'Addezio, C. D. Rowley, S. R. Smith, G. A. Jacobs, R. W. Helber, M. Yaremchuk, J. J. Osborne, 2020: Multi-scale assimilation of simulated SWOT observations. Ocean Modelling, 154, https://doi.org/10.1016/j.ocemod.2020.101683.
25. Zeng, X., and Coauthors, Use of Observing System Simulation Experiments in the U.S., 2020: Bull. Amer. Meteor. Soc., 101(8), E1427-E1438. https://doi.org/10.1175/BAMS-D-19-0155.1.
26. Munk, W., and C. Wunsch, 1979: Ocean acoustic tomography: a scheme for large scale monitoring. Deep-Sea Res., 26A. https://doi.org/10.1016/01980149(79)90073-6.
27. Cornuelle, B., C. Wunsch, D. Behringer, T. Birdsall, M. Brown, R. Heinmiller, R. Knox, K. Metzger, W. Munk, J. Spiesberger, R. Spindel, D. Webb, and P. Worcester, 1985: Tomographic maps of the ocean mesoscale. Part 1: Pure acoustics. J. Phys. Oceano., 15, 133-152. https://doi.org/10.1175/15200485(1985)015%3C0133:TMOTOM%3E2.0.CO;2
28. Skarsoulis, E. K., and U. Send, 2000: One-step analysis of nonlinear traveltime data in ocean acoustic tomography. J. Atmos. Oceanic. Technol., 17, 240-254. https://doi.org/10.1175/1520-0426(2000)017%3C0240:0SAONT%3E2.0.CO;2
29. Dushaw, B. D., 2019: Ocean acoustic tomography in the North Atlantic. J. Atmos. Oceanic. Technol., 36, 183-202. http://doi.org/10.1175/JTECH-D-18-0082.1.
30. Hursky, P., M. B. Porter, B. D. Cornuelle, W. S. Hodgkiss, and W. A. Kuperman, 2004: Adjoint modeling for acoustic inversion. J. Acoust. Soc. Am., 115(2), 607-619. https://doi.org/10.1121/1.1636760
31. Charpentier, I., and P. Roux, 2004: Mode and wavenumber inversion in shallow waterusing an adjoint method. J. Comput. Acoust., 12(4), 521-542. https://doi.org/10.1142/50218396X04002390
32. Storto, A., G. De Magistris, S. Falchetti, and P. Oddo, 2021: A neural network-based observation operator for coupled ocean-acoustic variational data assimilation. Mon. Wea. Rev., 149, 1967-1985. https://doi.org/10.1175/MWR-D-20-0320.1.
33. Cummings, J. A. and O. M. Smedstad, 2013: Variational data analysis for the global ocean. In: S. K. Park and L. Xu (Eds.), Data Assimilation for Atmospheric, Oceanic and Hydrologic Applications Vol. II., https://doi.org/10.1007/978-3 -642-35088-7_13, Springer-Verlag Berlin Heidelberg.
34. Carnes, M., R. W. Helber, C. N. Barron, J. M. Dastugue, 2010: Validation test report for GDEM4. NRL Tech. Rep. NRL/MR/7330-10-9271, 66 pp.
35. Lorenc, A. C., 1986: Analysis methods for numerical weather prediction. Quart. J. Roy. Meteor. Soc., 112, 1177-1194.
36. Evenson, G., 1996: Advanced data assimilation for strongly nonlinear dynamics. Mon. Wea. Rev., 125, 1342-1354.
37. Bishop, C. H., B. J. Etherton, and S. J. Majumdar, 2001: Adaptive sampling with the ensemble transform Kalman filter. Part I: theoretical aspects. Mon. Wea. Rev., 129, 420-436.
38. Hunt, B. R., E. Kostelich, and I. Szunyogh, 2007: Efficient data assimilation for spatiotemporal chaos: A local ensemble transform Kalman filter. Physica D, 230, 112-126.
39. Weaver, A., and P. Courtier, 2001: Correlation modelling on the sphere using a generalized diffusion equation. Q. J. Roy. Meteor. Soc., 127, 1815-1846, https://doi.org/10.1002/qj.49712757518
40. Carrier, M. J., H. Ngodock, 2010: Background-error correlation model based on the implicit solution of a diffusion equation. Ocean Modell., 35, 45-53.
41. Weaver, A. T., C. Deltel, E. Machu, S. Ricci, and N. Daget, 2005: A multivariate balance operator for variational ocean data assimilation. Q. J. Roy. Meteor. Soc., 131, 3605-3625, https://doi.org/10.1256/qj.05.119.
42. Gratton, S., and J. Tshimanga, 2009: An observation-space formulation of variational assimilation using a restricted preconditioned conjugate gradient algorithm. Q. J. Roy. Meteorolo. Soc., 135, 1573-1585, https://doi.org/10.1002/qj.477
43. Souopgui, I., H. Ngodock, M. Carrier, and S. Smith, 2017: A comparison of two preconditioner algorithms within the representer-based four-dimensional variational data assimilation system for the Navy Coastal Ocean Model. J. Oper. Oceano., https://dx.doi.org/10.1080/1755876X.2017.1306376
44. Halliwell, G. R., A. Srinivasan, V. H. Kourafalou, H. Yang, D. Willey, M. Le Henaff, and R. Atlas 2014. Rigorous evaluation of a fraternal twin ocean OSSE system for the Open Gulf of Mexico. J. Atmos. Oceanic Technol., 31, 105-130.

What is claimed is:

1. A method of determining ocean state, the method comprising:
receiving, by a processing device, data associated with a prior ocean forecast state;
receiving, by the processing device, data associated with a first set of ocean temperature and salinity observations;
receiving, by the processing device, data associated with a first set of ocean acoustic pressure observations;
determining, by the processing device, a correction to the prior ocean forecast state based on a forward acoustic model, on an adjoint acoustic model, on the data associated with a first set of ocean temperature and ocean salinity observations, and on the data associated with a first set of ocean acoustic pressure observations; and
generating, by the processing device, a current ocean state based on the determined correction.

2. The method of claim 1, wherein the first set of ocean acoustic pressure observations are captured by one or more hydrophones.

3. The method of claim 1, further comprising determining a set of one or more model fields based on the first set of ocean temperature and ocean salinity observations, wherein determining the correction to the prior ocean state comprises mapping the set of one or more model fields to an acoustic observation space and comparing the mapped set to the first set of ocean acoustic pressure observations.

4. The method of claim 3, further comprising comparing the mapped set to the first set of ocean acoustic pressure observations via an observation operator.

5. The method of claim 1, further comprising providing the first set of ocean acoustic pressure observations to the adjoint acoustic data model via an adjoint of an observation operator.

6. The method of claim 1, wherein the data associated with a prior ocean forecast state comprises assimilated data taken at a plurality of frequencies.

7. The method of claim 6, wherein determining the correction to the prior ocean forecast state comprises determining multi-scale corrections to the prior ocean forecast state based on the plurality of frequencies.

8. The method of claim 7, wherein a lower frequency is associated with a broad-scale feature correction, and a higher frequency is associated with small-scale feature correction.

9. The method of claim 1, wherein the first set of ocean acoustic pressure observations is based on acoustic pressure assimilation, wherein the acoustic pressure assimilation is based on a difference between recorded pressure values and one or more modeled values.

10. The method of claim 1, further comprising conducting a water-based operation based on the determined current ocean state.

11. The method of claim 1, further comprising causing display of the current ocean state.

12. A system for determining an ocean state, the system comprising:
a processing device; and
a memory device operably coupled to the processing device, the memory device storing computer-readable instructions that, when executed, cause the processing device to perform:
receiving data associated with a prior ocean forecast state;
receiving data associated with a first set of ocean temperature and salinity observations;
receiving data associated with a first set of ocean acoustic pressure observations;
determining a correction to the prior ocean forecast state based on a forward acoustic model, an adjoint acoustic model, the data associated with a first set of ocean temperature and ocean salinity observations, and the data associated with a first set of ocean acoustic pressure observations; and
generating a current ocean state based on the determined correction.

13. The system of claim 12, wherein the first set of ocean acoustic pressure observations are collected by one or more hydrophones

14. The system of claim 12, wherein the computer-readable instructions that, when executed, further cause the processing device to perform determining a set of one or more model fields based on the first set of ocean temperature and ocean salinity observations, wherein determining the correction to the prior ocean state comprises mapping the set of one or more model fields to an acoustic observation space and comparing the mapped set to the first set of ocean acoustic pressure observations.

15. The system of claim 14, wherein the computer-readable instructions that, when executed, further cause the processing device to perform comparing the mapped set to the first set of ocean acoustic pressure observations via an observation operator.

16. The system of claim 12, wherein the computer-readable instructions that, when executed, further cause the processing device to perform providing the first set of ocean acoustic pressure observations to the adjoint acoustic data model via an adjoint of an observation operator.

17. The system of claim 12, wherein the data associated with a prior ocean forecast state comprises assimilated data taken at a plurality of frequencies.

18. The system of claim 17, wherein determining the correction to the prior ocean forecast state comprises determining multi-scale corrections to the prior ocean forecast state based on the plurality of frequencies.

19. The system of claim 18, wherein a lower frequency is associated with a broad-scale feature correction, and a higher frequency is associated with small-scale feature correction.

20. The system of claim 12, wherein the first set of ocean acoustic pressure observations is based on acoustic pressure assimilation, wherein the acoustic pressure assimilation is based on a difference between recorded pressure values and one or more modeled values.

21. The system of claim 12, wherein the computer-readable instructions that, when executed, further cause the processing device to perform conducting a water-based operation based on the determined current ocean state.

22. The system of claim 12, wherein the computer-readable instructions that, when executed, further cause the processing device to perform causing display of the current ocean state.

23. A non-transitory computer readable medium comprising computer-readable instructions, the computer-readable instructions, when executed, cause a processing device to perform:
receiving data associated with a prior ocean forecast state;
receiving data associated with a first set of ocean temperature and salinity observations;
receiving data associated with a first set of ocean acoustic pressure observations;
determining a correction to the prior ocean forecast state based on a forward acoustic model, an adjoint acoustic model, the data associated with a first set of ocean temperature and ocean salinity observations, and the data associated with a first set of ocean acoustic pressure observations; and
generating a current ocean state based on the determined correction.

24. The non-transitory computer readable medium of claim 23, wherein the first set of ocean acoustic pressure observations are collected by one or more hydrophones

25. The non-transitory computer readable medium of claim 23, wherein the computer-readable instructions that, when executed, further cause the processing device to perform determining a set of one or more model fields based on the first set of ocean temperature and ocean salinity observations, wherein determining the correction to the prior ocean state comprises mapping the set of one or more model fields to an acoustic observation space and comparing the mapped set to the first set of ocean acoustic pressure observations.

26. The non-transitory computer readable medium of claim 25, wherein the computer-readable instructions that, when executed, further cause the processing device to perform comparing the mapped set to the first set of ocean acoustic pressure observations via an observation operator.

27. The non-transitory computer readable medium of claim 23, wherein the computer-readable instructions that, when executed, further cause the processing device to perform providing the first set of ocean acoustic pressure observations to the adjoint acoustic data model via an adjoint of an observation operator.

28. The non-transitory computer readable medium of claim 23, wherein the data associated with a prior ocean forecast state comprises assimilated data taken at a plurality of frequencies.

29. The non-transitory computer readable medium of claim 28, wherein determining the correction to the prior ocean forecast state comprises determining multi-scale corrections to the prior ocean forecast state based on the plurality of frequencies.

30. The non-transitory computer readable medium of claim 29, wherein a lower frequency is associated with a broad-scale feature correction, and a higher frequency is associated with small-scale feature correction.

31. The non-transitory computer readable medium of claim 23, wherein the first set of ocean acoustic pressure observations is based on acoustic pressure assimilation, wherein the acoustic pressure assimilation is based on a difference between recorded pressure values and one or more modeled values.

32. The non-transitory computer readable medium of claim 23, wherein the computer-readable instructions that, when executed, further cause the processing device to perform conducting a water-based operation based on the determined current ocean state.

33. The non-transitory computer readable medium of claim 23, wherein the computer-readable instructions that, when executed, further cause the processing device to perform causing display of the current ocean state.
